(19) United States
(12) Patent Application Publication
(10) Pub. No.: US 2025/0213906 A1
(43) Pub. Date: Jul. 3, 2025

(54) SMART FIRE EXTINGUISHER INSTALLATION AND MONITORING SYSTEMS

(71) Applicant: HEXMODAL TECHNLOGIES LLC, Brooklyn, NY (US)

(72) Inventors: Christian de Abreu, New York, NY (US); Utkarsh Shah, New York, NY (US)

(21) Appl. No.: 18/931,010

(22) Filed: Oct. 29, 2024

Related U.S. Application Data
(60) Provisional application No. 63/617,048, filed on Jan. 2, 2024.

(51) Int. Cl. A62C 37/50; A62C 13/78

(52) U.S. Cl. CPC A62C 37/50; A62C 13/78

(57) ABSTRACT

Systems and techniques are provided for installing fire extinguishers and monitoring the fire extinguishers using sensors. An example method can include obtaining sensor data collected by sensors while a fire extinguisher is mounted to a structure, the sensor data including an image depicting a pressure gauge of the fire extinguisher; determining information about a pressure of the fire extinguisher based on the image depicting the pressure gauge; determining a weight of the fire extinguisher based on a weight measurement in the sensor data, wherein the weight measurement is generated by a weight sensor on a mount used to mount the fire extinguisher to the structure; and generating a notification including the information about the pressure of the fire extinguisher, the weight of the fire extinguisher, and/or compliance information associated with the fire extinguisher, the compliance information being based on the information about the pressure and/or weight of the fire extinguisher.

### CROSS-REFERENCE TO RELATED APPLICATIONS

This application claims the benefit of, and priority to, U.S. Provisional Application No. 63/617,048, filed on Jan. 2, 2024, and entitled “FIRE EXTINGUISHER SENSOR SYSTEM”, the content of which is hereby expressly incorporated by reference in its entirety and for all purposes.

### BACKGROUND

### 1. Technical Field

The present disclosure generally relates to installing and monitoring fire extinguishers. For example, aspects of the present disclosure relate to systems and techniques for using smart fire extinguisher installation systems to install fire extinguishers and monitor conditions of the fire extinguishers based on sensor data collected by the smart fire extinguisher installation system.

### 2. Introduction

A fire extinguisher is a portable and/or handheld fire protection device that includes a vessel or container that can be filled with a chemical(s) used to extinguish or control fires. The fire extinguisher can include a discharge mechanism, such as a nozzle, that can be used when necessary to discharge the chemical(s) in the vessel or container onto a fire in order to extinguish or control the fire. For example, the discharge mechanism can be used when necessary to spray the chemical(s) onto the fire in order to extinguish or control the fire. Fire extinguishers are often mounted on or attached onto a structure (e.g., a wall or any other structure) or placed within a cabinet for fast and easy access by users during an emergency. In such cases, the fire extinguishers can quickly be retrieved from the structure or cabinet by a user during a fire emergency for use by the user to help extinguish or control a fire that triggered the fire emergency.

Generally, there are governing bodies that create rules and regulations that mandate fire extinguisher requirements for any particular location such as, for example, the number of fire extinguishers required at a location, requirements related to user access, requirements related to the location and/or placement of fire extinguishers, requirements related to fire extinguisher states or conditions, among other potential requirements which may vary by jurisdiction and/or geographic area. For example, a governing body in a particular jurisdiction or geographic area may specify compliance requirements relating to ease of access by users as well as fire extinguisher maintenance. The fire extinguisher maintenance requirements can include, for example and without limitation, requirements for maintaining a pressure, fill, and/or weight of each fire extinguisher; requirements for ensuring that the fire extinguishers at a location have not been tampered with or moved to a non-compliant location (and/or without proper approval/permission), etc.

### BRIEF DESCRIPTION OF THE DRAWINGS

Certain features of the subject technology are set forth in the detailed description. However, the accompanying drawings, which are included to provide further understanding, illustrate disclosed aspects and, together with the description, serve to provide examples of the subject technology and explain principles, techniques, and other aspects of the subject technology. Accordingly, illustrative examples of the present application are described in detail below with reference to the following figures:

FIG. 1 is a diagram illustrating an example environment that can be used to implement a smart fire extinguisher installation system, according to some examples of the present disclosure;

FIG. 2 is a diagram illustrating an example of a processing system of a smart assembly and various sensors used to collect sensor data associated with a fire extinguisher, according to some examples of the present disclosure;

FIG. 3A is a diagram illustrating an example form factor of a smart fire extinguisher installation system, according to some examples of the present disclosure;

FIG. 3B is a diagram illustrating a fire extinguisher installed using a smart fire extinguisher installation system implementing the example form factor shown in FIG. 3A, according to some examples of the present disclosure;

FIG. 4A is a diagram illustrating another example form factor of a smart fire extinguisher installation system, according to some examples of the present disclosure;

FIG. 4B is a diagram illustrating a fire extinguisher installed using a smart fire extinguisher installation system implementing the example form factor shown in FIG. 4A, according to some examples of the present disclosure;

FIG. 5A is a diagram illustrating another example form factor of a smart fire extinguisher installation system, according to some examples of the present disclosure;

FIG. 5B is a diagram illustrating a fire extinguisher installed using a smart fire extinguisher installation system implementing the example form factor shown in FIG. 5A, according to some examples of the present disclosure;

FIG. 6A is a diagram illustrating another example form factor of a smart fire extinguisher installation system, according to some examples of the present disclosure;

FIG. 6B is a diagram illustrating a fire extinguisher installed using a smart fire extinguisher installation system implementing the example form factor shown in FIG. 6A, according to some examples of the present disclosure;

FIG. 7A is a diagram illustrating an example smart fire extinguisher installation system that includes an example cabinet, according to some examples of the present disclosure;

FIG. 7B illustrates another example configuration of a smart mount, according to some examples of the present disclosure;

FIG. 8A is a diagram illustrating an example implementation of a smart fire extinguisher installation system that includes a backstop for a fire extinguisher, according to some examples of the present disclosure;

FIG. 8B is a diagram illustrating an example sensor implementation used to monitor a fire extinguisher, according to some examples of the present disclosure;

FIG. 8C is a diagram illustrating an example view of a coupling of a sensor apparatus of an example sensor implementation used to monitor a fire extinguisher, according to some examples of the present disclosure;

FIG. 9 is a flowchart illustrating an example process for processing fire extinguisher data used to monitor a fire extinguisher, according to some examples of the present disclosure;

FIG. 10 is a flowchart illustrating an example process for monitoring a fire extinguisher based on data collected from one or more sensors associated a smart fire extinguisher installation system used to mount the fire extinguisher, according to some examples of the present disclosure;

FIG. 11 is a flowchart illustrating an example process for installing and monitoring a fire extinguisher, according to some examples of the present disclosure;

FIG. 12 is a diagram illustrating an example architecture of an example neural network, according to some examples of the present disclosure; and

FIG. 13 illustrates an example processor-based system with which some aspects of the subject technology can be implemented.

### DETAILED DESCRIPTION

Certain aspects and examples of this disclosure are provided below. Some of the aspects and examples of this disclosure may be applied independently and/or in combination as would be apparent to those of skill in the art. In the following description, for the purposes of explanation, specific details are set forth in order to provide a thorough understanding of aspects and examples of the application. However, it will be apparent that various aspects and examples may be practiced without these specific details. Moreover, the figures and description are not intended to be restrictive.

The ensuing description provides examples and embodiments only, and is not intended to limit the scope, applicability, or configuration of the disclosure. Rather, the ensuing description of various examples and embodiments will provide those of skill in the art with an enabling description for implementing an exemplary embodiment and any other examples or embodiments. It should be understood that various changes may be made in the function, configuration, number, type, characteristics, and/or arrangement of elements without departing from the scope of the application as set forth in the appended claims.

As previously explained, a fire extinguisher is a portable and/or handheld fire protection device that includes a vessel or container that can be filled with a chemical(s) used to extinguish or control fires. The chemical(s) can include a dry chemical or a wet chemical that has suitable properties for extinguishing or controlling fires. The fire extinguisher can include a discharge mechanism, such as a nozzle, that a user can use when necessary to discharge the chemical(s) in the vessel or container onto a fire to help extinguish or control the fire. For example, the discharge mechanism can include a nozzle that allows a user to spray the chemical(s) in the vessel or container onto a fire in order to help extinguish or control the fire.

In many cases, fire extinguishers may be mounted on (or attached to) a structure (e.g., a wall or any other structure) or placed within a cabinet for fast and easy access by users during an emergency. The mounts used to secure fire extinguishers on structures, such as walls, and the cabinets used to store fire extinguishers can be configured to allow users to quickly access the fire extinguishers as needed during fire emergencies. For example, in some cases, fire extinguishers can be mounted on walls using mounts configured to hold the fire extinguishers in place until needed. In addition to securing each fire extinguisher to a wall, a fire extinguisher mount can also be configured to allow any person to easily remove a fire extinguisher from the mount when a fire emergency arises, so the person can use the fire extinguisher to assist in the fire emergency. Similarly, the cabinets can provide fast and easy access to the fire extinguishers in the cabinets, and thus allow any person to easily remove a fire extinguisher from the cabinet when a fire emergency arises.

Government agencies typically create rules and regulations that impose fire extinguisher requirements, such as requirements mandating a minimum number of fire extinguishers that should be implemented at a given location (e.g., which can be based on characteristics of the location such as size, layout, building materials, geographic region, etc.), requirements relating to the location and/or placement of fire extinguishers at the given location, requirements relating to user access of fire extinguishers at the given location, requirements relating to the maintenance of fire extinguishers, requirements relating to a condition of each fire extinguisher at the given location, and/or any other requirements. For example, fire extinguisher regulations may mandate a minimum pressure, fill level, and/or weight that each fire extinguisher should maintain; a frequency in which a pressure, fill level, and/or weight of a fire extinguisher should be verified; prohibit obstructions to may increase the difficulty (or prevent) of a person accessing a fire extinguisher; prohibit tampering with fire extinguishers; mandate a frequency for verifying that a fire extinguisher has not been tampered with (or moved) and/or an access to the fire extinguisher is not obstructed; mandate periodic checks of a weight of any fire extinguisher; etc.

While fire extinguisher mounts and cabinets used to secure fire extinguishers to a structure (e.g., a wall, etc.) generally provide users easy access to the fire extinguishers when needed, the mounts and cabinets lack any capabilities for managing and monitoring the fire extinguishers in an automated fashion to ensure compliance with applicable rules and regulations. Consequently, a location that implements fire extinguishers as required by any applicable rules and regulations generally has to manually inspect the fire extinguishers at the location on a periodic basis to ensure that the location and each fire extinguisher at the location is in compliance with the applicable rules and regulations relating to fire extinguishers. However, manually inspecting each fire extinguisher at a location on a periodic basis can be onerous, costly, time consuming, and resource intensive, particularly at large locations and/or locations with a larger number of fire extinguishers. Moreover, reliance on manual inspections on a periodic basis can result in delays in detecting any compliance issues with applicable fire extinguisher rules and regulations, such as non-compliance of one or more fire extinguishers at the location. Such delays can even create safety risks, such as safety risks addressed by the applicable fire extinguisher rules and regulations.

Described herein are systems, apparatuses, processes (also referred to as methods), and computer-readable media (collectively referred to as “systems and techniques”) for using smart fire extinguisher installation systems to install fire extinguishers and monitor the fire extinguishers (and associated conditions) automatically based on sensor data collected by sensors associated with (e.g., implemented by) the smart fire extinguisher installation systems. For example, the smart fire extinguisher installation systems described herein can be used to install fire extinguishers at any given location and automatically monitor the fire extinguishers to ensure continued compliance with applicable rules and regulations, avoid non-compliance and associated safety risks, and reduce any delays in detecting and addressing any compliance issues detected with respect to any fire extinguishers.

To illustrate, a smart fire extinguisher installation system used to secure a fire extinguisher to a wall can use sensors to detect, in an automated fashion, the pressure, fill level, and/or weight of the fire extinguisher and ensure that the pressure, fill level, and/or weight of the fire extinguisher is within the range of pressures, fill levels, and/or weights permitted by the applicable rules and regulations. If the smart fire extinguisher installation system detects that the pressure, fill level, and/or weight of a fire extinguisher is outside of a permissible range (and thus non-compliant with the applicable rules and regulations), the smart fire extinguisher installation system can generate an alert or notification to inform the appropriate user(s) so the issue can be quickly resolved. In some examples, the smart fire extinguisher installation system can use sensors to detect any obstructions that may affect user access to a fire extinguisher and/or that may create compliance issues with respect to that fire extinguisher. In some cases, the smart fire extinguisher installation system can use sensors to detect potential tampering with any fire extinguishers and/or any other conditions that may impact the use, access, and/or compliance of the fire extinguishers.

The sensors used by a smart fire extinguisher installation system to monitor fire extinguishers can be part of, implemented by, integrated with, and/or communicatively coupled to the smart fire extinguisher installation system. For example, in some cases, the smart fire extinguisher installation system can include a mount or cabinet that includes one or more sensors used to monitor a fire extinguisher installed using the smart fire extinguisher installation system. In some cases, the mount or cabinet can include a custom mount or cabinet that includes/integrates the one or more sensors. In other cases, the mount or cabinet can include any existing mount or cabinet, such as a conventional or “off-the shelf” mount or cabinet. In such cases, the mount or cabinet can be adapted to include/integrate the one or more sensors. Thus, the smart fire extinguisher installation system can implement any mount or cabinet used by a customer, including any existing or conventional mount or cabinet, which can be adapted as described herein. This way, customers are not forced to replace their fire extinguisher mounts or cabinets in order to implement the systems and techniques described herein, and can instead reuse their mounts or cabinets (and any other fire extinguisher component or installation component) as described herein.

In some aspects, a smart fire extinguisher installation system can include a processing system that can obtain sensor data from any of the sensors implemented by the smart fire extinguisher installation system. The processing system can use the sensor data to perform some or all of the monitoring and/or data processing tasks described herein, such as object detection, obstruction detection, tamper detection, classification (e.g., pressure gauge classification, etc.), recognition, data processing/pre-processing, alert/notification tasks, etc. In some cases, the processing system can perform some monitoring and/or data processing/preprocessing tasks locally, such as sensor data preprocessing and pressure gauge detection tasks, and offload other tasks to a remote system, such as other data processing/preprocessing tasks, other detection tasks, other classification tasks, other recognition tasks, other notification tasks, etc.

The processing system can include one or more processing components, such as one or more microcontrollers, central processing units (CPUs), graphics processing units (GPUs), digital signal processors (DSPs), image signal processors (ISPs), integrated circuits, processor cores, application-specific integrated circuits (ASICs), field-programmable gate arrays (FPGAs), system-on-chips (SoCs), single-board computers (SBCs), a printed circuit board (PCB), etc. The one or more processing components can obtain sensor data from one or more sensors and perform one or more processing tasks as described herein. The processing system can also include one or more communication devices used to send and receive data. For example, the processing system can include one or more wired and/or wireless communication devices, such as a cellular antenna/transceiver, a WIFI interface, a Bluetooth antenna, an Ethernet card, etc. The processing system can use the one or more communication devices to receive data (e.g., sensor data, other data, etc.), communicate data (e.g., sensor data, processing results, notifications, etc.) to remote devices, etc. In some examples, if the smart fire extinguisher installation system (and/or a remote management system) detects a non-compliance issue with a fire extinguisher, the smart fire extinguisher installation system can generate an alert and use the one or more communication devices to send the alert to one or more remote devices in order to notify one or more users about the non-compliance issue.

The smart fire extinguisher installation system can determine whether a fire extinguisher is in compliance with applicable rules and regulations locally using the processing system and/or in collaboration with a remote system, such as a remote server, datacenter, cloud network, etc. For example, the smart fire extinguisher installation system can determine a fire extinguisher's compliance with applicable rules and regulations at least partly based on data collected from one or more sensors, and/or can use the data from the one or more sensors to provide a remote system relevant data used by the remote system to make (and/or assist with) such determinations. The one or more sensors can be integrated into a mount used by the smart fire extinguisher installation system, a cabinet used by the smart fire extinguisher installation system, and/or a smart assembly used by the smart fire extinguisher installation system. Thus, as discussed in further detail below, at least some of the fire extinguisher management and monitoring functionalities/features described herein can be at least partly implemented by, through, or using a smart mount, a smart cabinet, a smart assembly that includes the processing system, and/or any other component of the smart fire extinguisher installation system described herein.

Moreover, the smart fire extinguisher installation system can implement a smart mount of any type or configuration such as, for example, a smart mount that uses a hook to secure a fire extinguisher, a smart mount with a single or dual-prong configuration, a smart mount with a bracket configuration, and/or any other mount configuration. The smart mount can communicate with the processing system implemented by a smart assembly of the smart fire extinguisher installation system, to provide relevant data to the processing system, such as relevant sensor data. The smart mount can communicate with the processing system using any wired and/or wireless communication protocol and/or device such as, for example, a wireless communication device, an Ethernet card, a wired or wireless network interface card, a Bluetooth radio, a Japan Solderless Terminal (JST) connector, a data bus, a WIFI connection, and/or any other wired and/or wireless communication device and/or protocol.

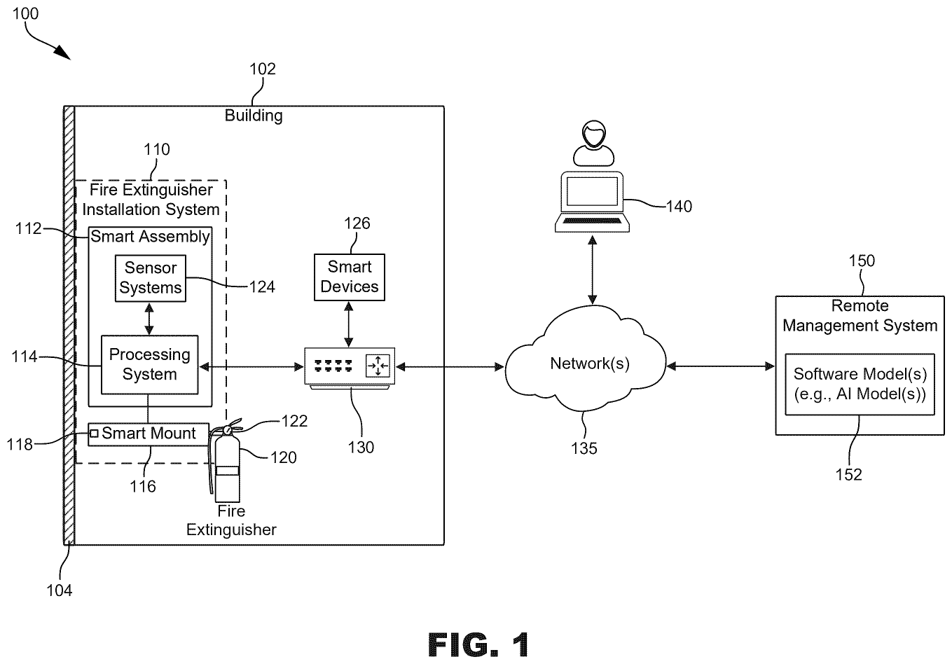

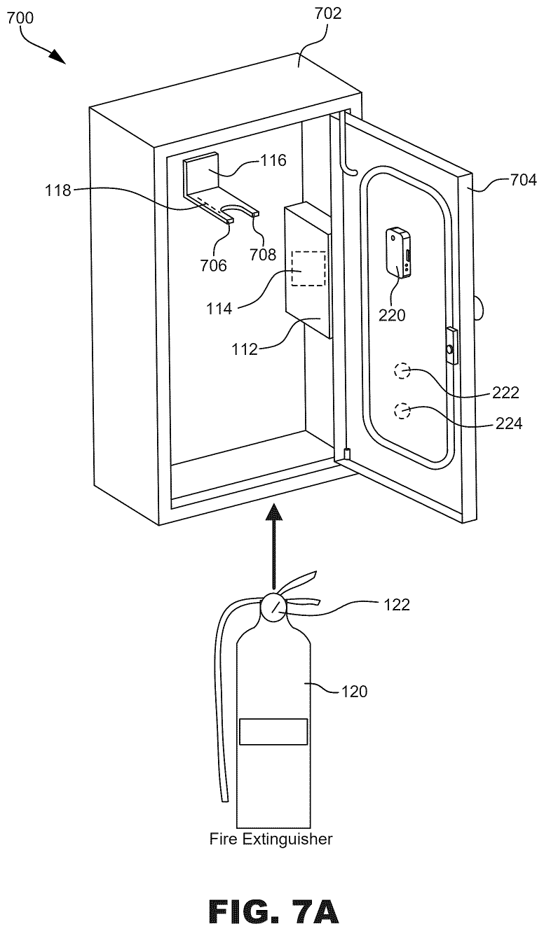

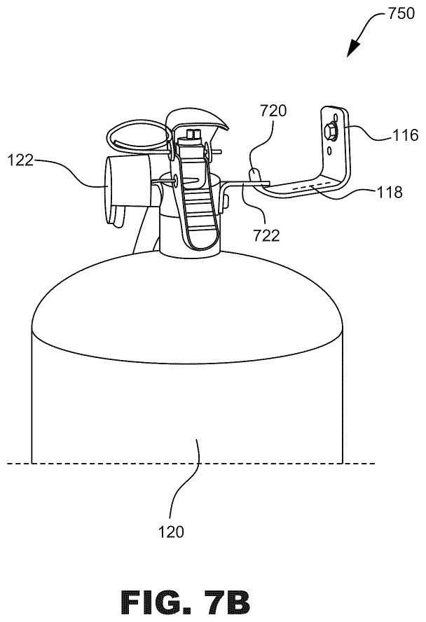

FIG. 1 is a diagram illustrating an example environment 100 that can be used to implement a smart fire extinguisher installation system 110, according to some examples of the present disclosure. As shown, the example environment 100 includes a building 102 with a fire extinguisher 120 installed using the smart fire extinguisher installation system 110. Here, the fire extinguisher 120 is secured to a structure 104 of the building 102 using a smart mount 116. However, in other examples, the fire extinguisher 120 can be placed within a smart cabinet, such as the smart cabinet 702 shown in FIG. 7A.

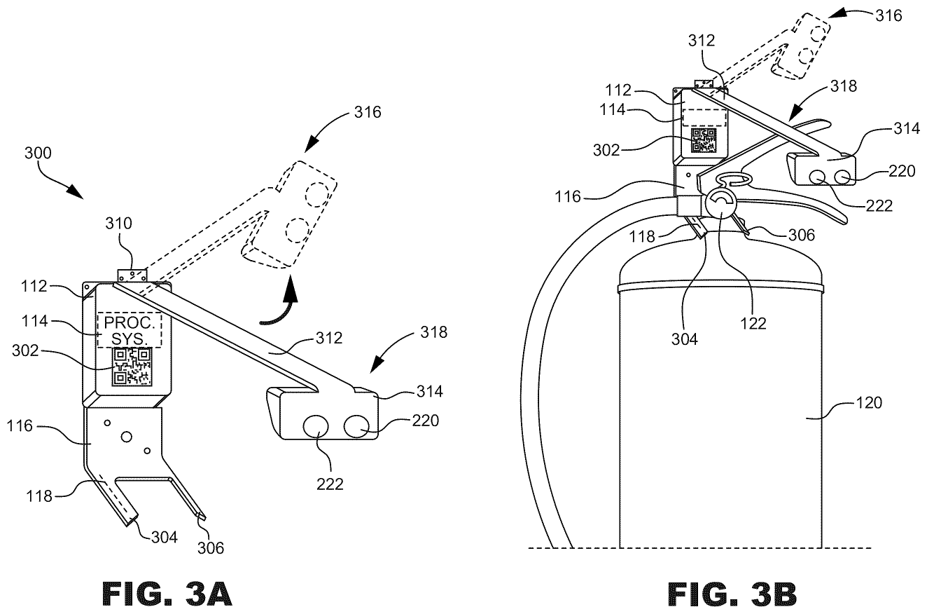

The structure 104 can include any physical structure onto which the fire extinguisher 120 can be mounted on (e.g., secured/attached to, etc.). For example, the structure 104 can include a wall, a beam, a fixture, or any other structure in the building 102. The smart mount 116 can include any type of mount such as, for example, a mount that uses a hook or single-prong configuration to secure the fire extinguisher 120 as shown in FIG. 7B, a mount with a dual-prong configuration as shown in FIGS. 3A through 6B, a smart mount with a bracket configuration, and/or any other mount configuration. Moreover, the smart mount 116 can include one or more sensors used to measure one or more conditions associated with the fire extinguisher 120. For example, in FIG. 1, the smart mount 116 includes a weight sensor(s) 118 used to measure a weight of the fire extinguisher 120 mounted on the structure 104 using the smart mount 116. In other words, the weight sensor(s) 118 can measure a weight applied on the weight sensor(s) 118 and the smart mount 116 by the fire extinguisher 120 when the fire extinguisher 120 is on the smart mount 116 or a lack of weight applied on the weight sensor(s) 118 and the smart mount 116 when the fire extinguisher 120 is not on the smart mount 116.

The weight applied on the weight sensor(s) 118 and the smart mount 116 can be used to determine a weight of the fire extinguisher 120. The weight of the fire extinguisher 120 can be used to estimate a fill level of the fire extinguisher 120 and/or determine whether a weight of the fire extinguisher 120 is within a weight threshold or range allowed or required by any applicable rules or regulations. In some examples, a lack of weight (or a weight below a threshold) applied on the weight sensor(s) 118 and the smart mount 116 can be used to detect that the fire extinguisher 120 has been removed from the smart mount 116, and a subsequent weight (or a subsequent weight above a threshold) applied on the weight sensor(s) 118 and the smart mount 116 can be used to detect that the fire extinguisher 120 has been returned to the smart mount 116.

The weight sensor(s) 118 on the smart mount 116 can include one or more weight sensors. For example, the weight sensor(s) 118 can include a weight sensor on a prong of the smart mount 116 or multiple weight sensors on multiple prongs of the smart mount 116 in the case of a multi-prong mount configuration. Moreover, the weight sensor(s) 118 can include any type of weight, tension, or compression sensor such as, for example, a capacitive weight sensor, a vibrating weight sensor, a gyro weight sensor, a resistance strain weight sensor, an electromagnetic force weight sensor, a hydraulic weight sensor, a photoelectric weight sensor, and/or any other weight, tension, or compression sensor. In some examples, the weight sensor(s) 118 can include a strain gauge on the smart mount 116. For example, the weight sensor(s) 118 can include a strain gauge on a prong or hook of the smart mount 116 or respective strain gauges on multiple prongs of the smart mount 116 (e.g., in a multi-prong configuration). In some cases, multiple strain gauges can be implemented on a given prong or hook of the smart mount 116.

To illustrate, a strain gauge can be implemented on a side of a prong or hook of the smart mount 116 and another strain gauge can be implemented on another side of the prong or hook of the smart mount 116. If the smart mount 116 has any other prongs, each of the other prongs may or may not include any strain gauges. For example, each of the other prongs may not include any strain gauges, may include a single strain gauge, or may include multiple strain gauges. In some examples, because strain gauges may be temperature sensitive, multiple strain gauges may be implemented by the smart mount 116 to ensure that temperature-induced errors are minimized, leading to more accurate strain measurements.

The strain gauge can measure any change in electrical properties (e.g., resistance, voltage, or current) caused when a mechanical force is applied to the strain gauge on the smart mount 116. The mechanical force can result from the weight of the fire extinguisher 120 being applied to the strain gauge when the fire extinguisher 120 is mounted on the structure 104 using the smart mount 116. The strain gauge can convert the change in electrical properties caused by the force applied by the fire extinguisher 120 into a weight measurement. For example, if a strain gauge is implemented on a prong of the smart mount 116, when the fire extinguisher 120 is placed on the smart mount 116, the weight from the fire extinguisher 120 will apply mechanical force on the prong and the strain gauge, which may cause the prong and strain gauge to slightly bend. The slight bending of the prong and strain gauge causes changes in the electrical properties of the prong and strain gauge, such as changes in resistance, voltage, and/or current. The changes in electrical properties can be converted into a weight representing the weight of the fire extinguisher 120 measured based on the changes in electrical properties caused by the bending of the prong and strain gauge when the mechanical force from the weight of the fire extinguisher 120 is applied to the prong and strain gauge.

In some cases, the software model(s) 210 on the smart assembly 112 and/or the software model(s) 152 on the remote management system 150 can include a software model that models how a prong of the smart mount 116 used to implement a strain gauge (e.g., from the weight sensor(s) 118) bends over time. This information can be used to calibrate/recalibrate the strain gauge to account for such bending over time. For example, if the weight sensor(s) 118 includes a strain gauge implemented on a prong of the smart mount 116, the accuracy of the strain gauge over time may decrease as a result of creep resulting from the prong of the smart mount 116 bending over time, which can affect the weight readings from the strain gauge. Accordingly, the software model(s) 210 on the smart assembly 112 and/or the software model(s) 152 on the remote management system 150 can include a software model that models how the prong of the smart mount 116 bends over time (e.g., from mechanical force applied to it by the weight of fire extinguishers placed on the smart mount 116, because of any environmental factors, because of the material of the prong, and/or because of any other reason). The model of how the prong bends over time can be used to calculate a value(s) used to compensate for such bending when the strain gauge on the prong obtains a weight measurement to avoid or reduce any inaccuracies in the measured weight that would otherwise be introduced by the bending of the prong of the smart mount 116 over time if such bending was not accounted for in the weight measurements (e.g., by compensating for it as discussed above). In some cases, the model can be used to recalibrate the strain gauge measurements over time, such as at certain intervals (e.g., every n number of time units, every interval modeled to result in a threshold amount of additional bending, etc.), as desired, on a schedule, and/or at any other time.

In some cases, the smart mount 116 can include or represent a customized mount that includes or integrates the weight sensor(s) 118 (e.g., a strain gauge(s)) to measure a weight of the fire extinguisher 120 when the fire extinguisher 120 is mounted using the smart mount 116 (and/or measure a lack of weight if the fire extinguisher 120 is removed from the smart mount 116). In other cases, the smart mount 116 can include or represent any fire extinguisher mount, such as an existing or conventional fire extinguisher mount, adapted to include or integrate the weight sensor(s) 118 used to measure a weight of the fire extinguisher 120 when the fire extinguisher 120 is mounted using the smart mount 116 (and/or measure a lack of weight if the fire extinguisher 120 is removed from the smart mount 116). This way, a customer associated with the building 102 can use any mount to implement the smart fire extinguisher installation system 110, and is not required to purchase a new or customized mount to use the smart fire extinguisher installation system 110.

For example, in some cases, the smart mount 116 can include an existing/conventional fire extinguisher mount of/from a customer associated with the building 102. The existing/conventional fire extinguisher mount can be adapted to include the weight sensor(s) 118. In some examples, the weight sensor(s) 118 can include a strain gauge(s), and the strain gauge(s) can include one or more wires placed on, adhered to, or embedded in a portion(s) of the mount, such as a prong or hook used by the mount to hold the fire extinguisher 120. When the fire extinguisher 120 is placed on the mount, the force from the fire extinguisher 120 can cause the one or more wires to bend a certain amount, which causes a change in the electrical properties (e.g., resistance, voltage, current) of the one or more wires. The one or more wires can measure that change in electrical properties, which can be converted into a weight measurement for the fire extinguisher 120.

In some cases, the weight sensor(s) 118 can be affixed to the smart mount 116 using an adhesive. The weight sensor(s) 118 can be positioned on the smart mount 116 according to an orientation that aligns with the expected direction of strain from the fire extinguisher 120 when the fire extinguisher 120 is on the smart mount 116. If the weight sensor(s) 118 includes one or more strain gauge wires, the one or more wires can be placed in a manner that ensures or provides strain relief for the one or more wires to prevent any mechanical stress on the weight sensor(s) 118. In some aspects, a protective coating or sealant can be applied to the weight sensor(s) 118 (or a surface of the weight sensor(s) 118) after the weight sensor(s) 118 is affixed to the smart mount 116 to protect the weight sensor(s) 118 from environmental factors such as moisture, dust, chemicals, etc. Once the weight sensor(s) 118 is added to or mounted on the smart mount 116, the weight sensor(s) 118 can be calibrated to ensure the weight sensor(s) 118 provides accurate readings.

In some examples, the weight sensor(s) 118 can be calibrated and tested using known weight loads. The known weight loads can be used to verify a performance of the weight sensor(s) 118. In some cases, the smart mount 116 can include one or more flex circuits and/or flex wires/cables. For example, in some cases, the smart mount 116 can include one or more flex wires/cables to interconnect the weight sensor(s) 118 with the processing system 114. In some cases, the smart mount 116 can include a flex circuit to implement the weight sensor(s) 118 and/or processing capabilities for the smart mount 116, in addition to the processing capabilities of the processing system 114.

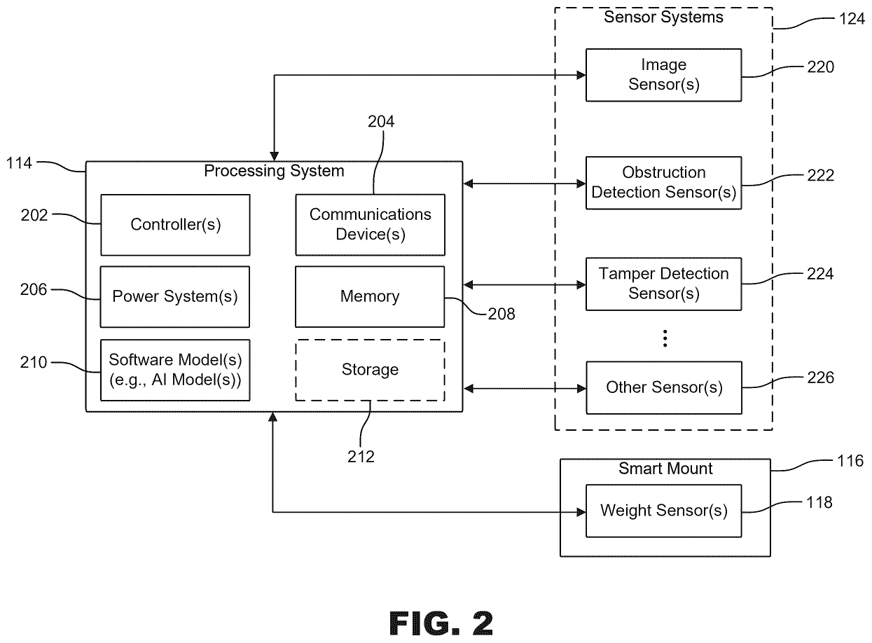

The smart fire extinguisher installation system 110 can also include a smart assembly 112. The smart assembly can contain and/or house a processing system 114. The processing system 114 can include one or more processing components, such as one or more microcontrollers, CPUs, GPUs, DSPs, ISPs, integrated circuits, processor cores, ASICs, FPGAS, SoCs, SBCs, PCBs, flexible (flex) circuits, and/or any other processing component(s). An example of the processing system 114 is shown in FIG. 2 and further described below with respect to FIG. 2. The processing system 114 can be communicatively coupled to the weight sensor(s) 118 of the smart mount 116 in order to receive measurements from the weight sensor(s) 118 of the smart mount 116. For example, the processing system 114 can communicate with the weight sensor(s) 118 of the smart mount 116 using a wired and/or wireless connection. In some cases, the processing system 114 can communicate with the weight sensor(s) 118 of the smart mount 116 via a JST connection, a data bus connection, or any other wired or wireless connection.

The processing system 114 can also be communicatively coupled to sensor systems 124 configured to collect sensor data used to monitor the fire extinguisher 120 as further described herein. The sensor systems 124 can include one or more sensors such as, for example and without limitation, one or more image/camera sensors, ultrasonic distance sensors, time-of-flight (TOF) sensors, inertial measurement units (or accelerometers and/or gyroscopes), radio detection and ranging (RADAR) sensors, light detection and ranging (LIDAR) sensors, light or ambient light sensors, infrared or laser distance sensors, and/or any other sensors. Non-limiting examples of sensors are illustrated in FIG. 2 and further described below with respect to FIG. 2.

The sensor data collected by the sensor systems 124 can include, for example, image data (e.g., images, video frames, etc.), distance measurements, motion measurements, position or pose measurements, impact measurements, ambient light measurements, and/or any other measurements. The sensor data can be used to detect any conditions related to the fire extinguisher 120, such as a pressure of the fire extinguisher 120, any physical obstructions that may obstruct a user access to the fire extinguisher 120, any tampering with the fire extinguisher 120, any changes in a position and/or motion of the fire extinguisher 120, whether the fire extinguisher 120 was moved to a different location/position, and/or any other conditions related to the fire extinguisher 120.

For example, in some cases, the sensor systems 124 can include a camera/image sensor used to capture images depicting a pressure gauge 122 of the fire extinguisher 120, which can be used to detect a pressure of the fire extinguisher 120 based on the pressure reading of the pressure gauge 122 depicted in the images. The images can be processed by one or more software models that can perform object detection to detect the pressure gauge 122 depicted in the images and perform classification to classify a pressure reading of the pressure gauge 122 as depicted in the images. As further described herein, the camera/image sensor can be positioned relative to the pressure gauge 122 such that the pressure gauge 122 is within the field-of-view (FOV) of the camera/image sensor. In some cases, the camera/image sensor can be located on the smart assembly 112 at a position relative to a position of the pressure gauge 122 when the fire extinguisher 120 is mounted on the smart mount 116 such that the pressure gauge 112 is within a view of the camera/image sensor and can thus be imaged by the camera/image sensor.

The processing system 114 can be communicatively coupled to the sensor systems 124 via one or more wired and/or wireless connections. For example, the processing system 114 can receive sensor data from the sensor systems 124 via a cellular connection, a WIFI connection, a Bluetooth connection, a JST connection, an Ethernet connection, a LoRa connection, a Zigbee connection, a data bus connection, a cable connection, and/or any other wired or wireless connection. In some cases, the processing system 114 and the sensor systems 124 can communicate via a backhaul or dedicated connection and/or network. For example, the processing system 114 and the sensor systems 124 can communicate via a connection and/or network that is dedicated for certain traffic, such as traffic from/to the sensor systems 124 and any emergency devices, and separated from other traffic such as user traffic, etc. To illustrate, in some cases, the building 102 can include a separate network and/or connection dedicated for traffic to/from an emergency system(s), such as an emergency light system. In this example, the processing system 114 and the sensor systems 124 can communicate via the separate network and/or connection dedicated for traffic to/from the emergency system(s), in order to separate the traffic associated with the sensor systems 124 from other traffic.

In some cases, the smart assembly 112 can include, implement, host, or house the sensor systems 124 (or a portion thereof). For example, the sensor systems 124 (or a portion thereof) can be mounted on, adhered to, and/or otherwise coupled to one or more surfaces and/or portions of the smart assembly 112. The sensor systems 124 can be placed on the smart assembly 112 at one or more positions that allow the sensor systems 124 to measure properties of the fire extinguisher 120 and an area used to access the fire extinguisher 120, in order to detect such properties of the fire extinguisher and the access area, as further described herein.

In other cases, the sensor systems 124 (or a portion thereof) can be separate from the smart assembly 112. For example, the sensor systems 124 can be attached to or implemented by/on another portion of the fire extinguisher installation system 110, a different structure, a different device, or any other location or component. Here, the sensor systems 124 can similarly be placed at one or more positions that allow the sensor systems 124 to measure properties of the fire extinguisher 120 and an area used to access the fire extinguisher 120, in order to detect such properties of the fire extinguisher and the access area, as further described herein.

The building 102 can also include a gateway 130 that connects the processing system 114 and optionally the sensor systems 124 to a network(s) 135. The network(s) 135 can include one or more private networks and/or one or more public networks such as, for example and without limitation, a wide area network (WAN), a cloud network, an Internet Service Provider network, a cellular network, a backbone network, and/or any other network. The network(s) 135 can interconnect the processing system 114 (and optionally the sensor systems 124) to remote systems/devices, such as user devices 140 and a remote management system 150. For example, the network(s) 135 can transport packets between the remote management system 150 and the processing system 114 (or optionally the sensor systems 124), or between the user devices 140 and the processing system 114 (or optionally the sensor systems 124).

The remote management system 150 can include or represent a remote server(s), datacenter(s), cloud(s), and/or any other remote system or network. The remote management system 150 can be configured to use data from the processing system 114 to detect conditions associated with the fire extinguisher 120, such as a pressure, fill, and/or weight of the fire extinguisher 120; any physical obstructions that may potentially obstruct a user access to the fire extinguisher 120; any tampering with the fire extinguisher 120; a location and/or position of the fire extinguisher 120; environmental conditions associated with the fire extinguisher 120; etc. For example, the processing system 114 can obtain sensor data from the sensor systems 124 and the weight sensor(s) 118 of the smart mount 116, and provide the sensor data to the remote management system 150 and/or data generated based on the sensor data. The remote management system 150 can use the data from the processing system 114 to detect and monitor conditions associated with the fire extinguisher 120, as further described herein.

In some examples, the remote management system 150 can include a software model(s) 152 that the remote management system 150 can use to process sensor data from the processing system 114 to detect and monitor conditions associated with the fire extinguisher 120. For example, the remote management system 150 can use the software model(s) 152 to detect objects depicted in image data, detect objects in an access area associated with the fire extinguisher 120, determine a position/location of objects relative to the fire extinguisher 120 to detect any potential obstructions, detect any tampering with the fire extinguisher 120, classify a pressure gauge reading based on image data depicting the pressure gauge 122 of the fire extinguisher 120, etc. The software model(s) 152 can include one or more algorithms/models. For example, the software model(s) 152 can include a classical or statistics-based algorithm, an artificial intelligence (AI) or machine learning (ML) model or neural network, etc.

In some cases, the remote management system 150 and/or the processing system 114 can generate alerts/notifications providing information regarding monitored/detected conditions associated with the fire extinguisher 120. For example, if the remote management system 150 or the processing system 114 detects a compliance issue with the fire extinguisher 120, the remote management system 150 or the processing system 114 can generate an alert with a notification about the compliance issue. The remote management system 150 or the processing system 114 can send the alert to a device, such as a client device from the client devices 140, to notify one or more users about the compliance event. In some cases, the remote management system 150 and/or the processing system 114 can generate notifications with monitoring results and/or store the monitoring results for user access, even if the monitoring results do not include a compliance issue.

In some aspects, the monitoring results from the remote management system 150 and/or the processing system 114 can be access by users from a database, a website, a monitoring application, and/or storage. For example, in addition to receiving alerts when a compliance issue is detected, a user may access other monitoring results from a database, a website, an application and/or a storage location.

FIG. 2 is a diagram illustrating an example of the processing system 114 and various sensors used to collect sensor data associated with the fire extinguisher 120. In this example, the processing system 114 can include a controller(s) 202, a communications device(s) 204, a power system(s) 206, a memory 208, a software model(s) 210, and optionally a storage device 212.

The controller(s) 202 can include or represent one or more processing components such as, for example and without limitation, one or more microcontrollers, CPUs, GPUs, DSPs, ISPs, integrated circuits, processor cores, ASICs, FPGAs, SoCs, SBCs, and/or any other processing component(s). The controller(s) 202 can process data from the sensor systems 124 and the weight sensor(s) 118 on the smart mount 116, as further described herein.

The communications device(s) 204 can include one or more wired and/or wireless communications devices such as, for example and without limitation, one or more cellular antennas, WIFI interfaces, Ethernet interfaces, Bluetooth interfaces, LoRaWAN interfaces, Zigbee interfaces, and/or any other wireless and/or wired communications devices. In some cases, the communications device(s) 204 can include multiple communications devices used for different traffic, networks, and/or device communications. For example, the communications device(s) 204 can include a communications device for communications with the remote management system 150 and/or the client devices 140, and one or more different communications devices for communications with the sensor systems 124 and/or the weight sensor(s) 118 on the smart mount 116. In some examples, the processing system 114 can use the communications device(s) 204 (e.g., a communications device from the communications device(s) 204 such as a long range (LoRa communications device, a WIFI communications device, an Ethernet card, etc.) to transmit data to the remote management system 150. The data can include sensor data (e.g., measurements, images, readings, etc.), monitoring reports (e.g., reports with monitoring information about the fire extinguisher 120 such as compliance information, compliance events, detection results, detected/monitored conditions, etc.), requests, instructions, and/or any other data.

The power system(s) 206 can supply power to the processing system 114. In some cases, the power system(s) 206 can include one or more batteries used to supply power to the processing system 114. In some cases, the power system(s) 206 can additionally or alternatively include a power supply or a connection to an external power source. The memory 208 can include any memory device used by the processing system 114, such as one or more volatile and/or non-volatile memory devices.

The memory 208 can include one or more memory devices used by the processing system 114. For example, the memory 208 can include one or more memory devices used by the controller(s) 202 of the processing system 114 to store data associated with an executed program or service, such as computer-readable code, state data, program variables, etc., Moreover, the memory 208 (e.g., the one or more memory devices) can include any type of memory such as, for example, volatile memory, flash memory, flashed-based memory (e.g., solid-state drive (SSD) memory), etc. In some examples, the memory 208 can include one or more volatile memory devices such as, for example, one or more random access memory (RAM) devices, one or more dynamic RAM (DRAM) devices, one or more static RAM (SRAM) devices, one or more synchronous DRAM (SDRAM) devices, one or more double data rate (DDR) devices (e.g., DDR, DDR2, DDR3, DDR4, etc.), one or more double data rate (DDR) SDRAM devices, and/or any other volatile memory device(s).

In some cases, the memory 208 can include a buffer or cache memory (e.g., system cache, L2 cache, etc.) used to store data such as computer-readable code, state data, program variables, etc. The memory 208 (or a memory device associated with the memory 208) can be part of the controller(s) 202 or separate from the controller(s) 202. For example, in some cases, the memory 208 (or a portion thereof) can include system/processor memory implemented by the controller(s) 202. In other cases, the memory 208 can additionally or alternatively include separate memory, such as a RAM device, a DDR device, an SSD device, a DRAM device, an SDRAM device, etc.

The software model(s) 210 can include one or more algorithms/models used to process sensor data from the sensor systems 124 and the weight sensor(s) 118. In some examples, the software model(s) 210 can be configured to detect and monitor one or more conditions associated with the fire extinguisher 120 based on the sensor data. For example, the processing system 114 can use the software model(s) 210 to detect objects depicted in image data, such as the pressure gauge 122 depicted in image data captured by the image sensor(s) 220; detect objects in an access area associated with the fire extinguisher 120; determine a position/location of objects relative to the fire extinguisher 120 to detect any potential obstructions; detect any tampering with the fire extinguisher 120; classify a pressure gauge reading based on image data depicting the pressure gauge 122 of the fire extinguisher 120; etc. In some examples, the software model(s) 210 can include one or more classical or statistics-based algorithms and/or one or more AI/ML models or neural network.

The storage device 212 can include any storage device(s) for storing data, such as a hard disk, an SSD memory device, and/or any non-volatile memory device. Moreover, the storage 108 can store data from any of the components of the image processing system 100. For example, the storage 108 can store data generated by, used by, stored by, and/or obtained from the controller(s) 202, the communications device(s) 204, the software model(s) 210, the weight sensor(s) 118, the sensor systems 124, the remote management system 150, etc.

The weight sensor(s) 118 on the smart mount 116 can be configured to measure a weight applied on the smart mount 116. The weight applied on the smart mount 116 can indicate the weight of the fire extinguisher 120 if the fire extinguisher 120 is on the smart mount 116, or can indicate whether the fire extinguisher 120 has been removed from the smart mount 116 (e.g., if no weight is detected or the weight detected is below a threshold). The weight sensor(s) 118 can communicate weight measurements to the processing system 114 via a wired or wireless connection between the weight sensor(s) 118 and the processing system 114. In some cases, the weight sensor(s) 118 can obtain weight measurements at specific time intervals, based on a specific schedule, in response to certain triggering events, and/or as requested. For example, the weight sensor(s) 118 can be configured to obtain weight measurements and send the weight measurements to the processing system 114 at specific time intervals. In some cases, the time intervals can vary based on context.

To illustrate, the time intervals set for obtaining weight measurements and sending the weight measurements to the processing system 114 when the fire extinguisher 120 is mounted on the smart mount 116 (or determined to be mounted on the smart mount 116) can be different than the time intervals set for obtaining and sending weight measurements after a determination that the fire extinguisher 120 has been removed from the smart mount 116 and before detecting that the fire extinguisher 120 has been placed back on the smart mount 116 (e.g., during periods when the fire extinguisher 120 is removed from the smart mount 116).

In some examples, the weight sensor(s) 118 can additionally or alternatively obtain weight measurements and send the weight measurements to the processing system 114 in response to requests for such measurements from the processing system 114. For example, the controller(s) 202 can be configured to request weight measurements from the weight sensor(s) 118 at specific times or time intervals and/or in response to certain events such as, for example, user inputs, detected conditions such as weight changes, etc. In some cases, the weight sensor(s) 118 can automatically send weight measurements to the processing system 114 any time a change in a force applied to the weight sensor(s) 118 and/or the smart mount 116 indicates a change in weight that exceeds a threshold change. To illustrate, if a user removes the fire extinguisher 120 from the smart mount 116, the change in weight caused by the user removing the fire extinguisher 120 from the smart mount 116 can trigger the weight sensor(s) 118 to obtain a weight measurement and send the weight measurement to the processing system 114.

As previously noted, the processing system 114 can obtain sensor data from the sensor systems 124 via the communications device(s) 204. The sensor systems 124 can include an image sensor(s) 220, an obstruction detection sensor(s) 222, a tamper detection sensor(s) 224, and optionally one or more other sensors 226. The image sensor(s) 220 can include one or more image sensors used to capture image data (e.g., still pictures, video frames), which can be used to detect conditions associated with the fire extinguisher 120, such as pressure/fill levels, physical obstructions obstructing access to the fire extinguisher 120, tampering of the fire extinguisher 120, etc. For example, the image sensor(s) 220 can be positioned on the smart assembly 112 such that the pressure gauge 122 of the fire extinguisher 120 is within a FOV of the image sensor(s) 220. This way, the image sensor(s) 220 can capture images depicting the pressure gauge 122 (as well as any other portion of the fire extinguisher 120 and/or a surrounding area that is/are within the FOV of the image sensor(s) 220). In some cases, the image sensor(s) 220 can include a fish-eye lens to accommodate for scenarios where the distance between the image sensor(s) 220 and the area where the pressure gauge 122 is estimated to be when the fire extinguisher 120 is on the smart mount 116 is below a threshold.

In some examples, the image data captured by the image sensor(s) 220 can be used to determine whether the fire extinguisher 120 is pressurized correctly, whether an access area associated with the fire extinguisher 120 (e.g., as defined by applicable rules or regulations, a predetermined area, etc.) is free from physical obstructions that may be prohibited by applicable rules or regulations, whether the fire extinguisher 120 is located in the correct location based on applicable rules or regulations, whether there are any visual tampering conditions (e.g., damage, unauthorized or prohibited movements, unauthorized or prohibited placement of the fire extinguisher 120 on the smart mount 116 or elsewhere, and/or any adjustments or interferences with a state and/or condition of any aspect of the fire extinguisher 120 that may interfere or conflict with any applicable rules or regulations), etc. For example, fire extinguishers can include a pressure gauge indicating the internal pressure of the fire extinguishers and the applicable rules or regulations of the fire extinguishers may require that fire extinguishers be pressurized above some predetermined value as indicated on the pressure gauge. Thus, the image data captured by the image sensor(s) 220 may depict an area where the fire gauge 122 is expected to be if the fire extinguisher 120 is properly on the smart mount 116, and such image data can be used to determine a pressure of the fire extinguisher 120 when the fire extinguisher 120 is on the smart mount 116.

In some cases, any images captured by the image sensor(s) 220 can be used by the software model(s) 210 of the processing system 114 and/or the software model(s) 152 of the remote management system 150 to determine whether the fire extinguisher 120 has been moved (e.g., based on a determination that the images do not depict the pressure gauge 122 and/or at least a portion of the fire extinguisher 120), classify a pressure level of the fire extinguisher 120 based on a pressure reading of the pressure gauge 122 depicted in the images and recognized from the images, determine any visible conditions of the fire extinguisher 120 depicted in the images and/or any visible conditions of any other areas depicted in the images, detect any obstructions depicted in the images, and/or determine any other visual conditions depicted in the images. For example, in some cases, the software model(s) 210 of the processing system 114 can use an image captured by the image sensor(s) 220 to detect whether the pressure gauge 122 is present (e.g., is depicted in the image). The processing system 114 can send data to the remote management system 150 including the image. The software model(s) 152 of the remote management system 150 can use the image to determine a pressure level of the fire extinguisher 120 by classifying a pressure reading of the pressure gauge 122 depicted in the image. The remote management system 150 can use the pressure level to determine whether there are any compliance issues associated with the fire extinguisher 120, such as pressure/fill compliance issues. In some cases, the remote management system 150 can generate an alert when it detects a compliance issue related to the pressure level of the fire extinguisher 120, which can notify users and/or devices of the compliance issue.

The obstruction detection sensor(s) 222 can include one or more sensors configured to detect whether there are any physical obstructions within an area relative to the fire extinguisher 120, such as a predetermined access area (e.g., an area relative to the fire extinguisher 120 that should remain free of obstructions (or certain types of obstructions) according to any relevant rules or regulations). The one or more sensors can be positioned relative to such area to be able to measure objects located within that area. For example, the one or more sensors can be positioned facing an area surrounding the fire extinguisher 120 that is required to be free of obstructions by any relevant rules or regulations.

The one or more sensors of the obstruction detection sensor(s) 222 can include any sensor that can be used to detect objects and/or a distance of objects, in order to detect any obstructions within an area relative to the fire extinguisher 120. For example, the one or more sensors of the obstruction detection sensor(s) 222 can include an ultrasonic sensor used to measure the distance of any objects relative to the fire extinguisher 120 (and/or the obstruction detection sensor(s) 222), a RADAR sensor used to measure the distance of objects, a LIDAR sensor used to measure the distance of objects, a TOF sensor used to measure the distance of objects, an image sensor used to capture images depicting an area that should be free from obstructions, and/or any other obstruction sensor. In some cases, distance measurements obtained by the obstruction detection sensor(s) 222 (e.g., distance measurements from an ultrasonic sensor, a RADAR sensor, a LIDAR sensor, a TOF sensor, etc.) can be used to determine whether there are any obstructions in an area relative to the fire extinguisher 120 by comparing the distance measurements with ground truth distance information (e.g., distance information corresponding to a scenario when the area relative to the fire extinguisher 120 did not include any obstructions or any prohibited obstructions). Here, an obstruction within the area can be detected if the distance measurements indicate that an object is present within the area and the ground truth distance information does not indicate that the object was present in the area when the ground truth distance information was collected (or indicates that the object was present in a different position or area).

In other cases, the distance measurements can be used to detect an obstruction even without ground truth distance information. For example, the software model(s) (e.g., software model(s) 152 or 210) can use the distance measurements to determine a distance and size/shape of any objects within an area relative to the fire extinguisher 120, and determine whether there is an obstruction based on the distance and size/shape of any objects within the area and any applicable rules or regulations used to determine what portion(s) of the area should be free from obstructions, what constitutes an obstruction that may trigger a non-compliance event, and/or what type of distance and size/shape measurements may trigger a non-compliance event. In some cases, the software model(s) can be trained, using distance measurements, to learn when to detect an obstruction as defined or prohibited by applicable rules or regulations. This way, the software model(s) can use the data from the obstruction detection sensor(s) 222 to detect any obstructions. In some examples, the distance measurements can be used to detect any obstructions within a range relative to the obstruction detection sensor(s) 222 and/or the fire extinguisher 120.

The tamper detection sensor(s) 224 can include one or more sensors configured to capture data about any conditions of the fire extinguisher 120 that may trigger a tampering event alert, such as moving the fire extinguisher 120 to a different location, damaging the fire extinguisher 120, damaging any component of the smart fire extinguisher installation system 110 that may increase a difficulty of removing the fire extinguisher 120 from the smart mount 116, etc. In some examples, the tamper detection sensor(s) 224 can include an image sensor configured to capture images used to detect any visual conditions indicative of a tampering event. In some cases, the tamper detection sensor(s) 224 can additionally or alternatively include an inertial measurement unit (IMU), a separate accelerometer, a separate gyroscope, an impact sensor, and/or any other type of tamper sensor. In some aspects, the tamper detection sensor(s) 224 can obtain measurements at specific intervals, which can be used to detect any tampering events, generate any alerts notifying about any detected tampering events, and/or request any corrective actions.

For example, in some cases, the tamper detection sensor(s) 224 can include an accelerometer and gyroscope used to determine any linear or angular motion of the fire extinguisher 120. The linear or angular motion can be used to determine whether the fire extinguisher 120 was moved, tampered with, removed from the smart mount 116, and/or returned to the smart mount 116.

The data from the tamper detection sensor(s) 224 can be used in combination with data from other sensors to detect tampering events and/or any other conditions. For example, if the tamper detection sensor(s) 224 detects tampering with a cabinet door, the tampering may simply be caused by a door of the cabinet being opened accidentally, may be caused by the fire extinguisher 120 being moved, or may be caused by the fire extinguisher 120 being used and returned. By using the measurements from the tamper detection sensor(s) 224 with data from other sensors, such as the weight sensor(s) 118, the image sensor(s) 220, the obstruction detection sensor(s) 222, etc., the software model(s) can determine which of the example scenarios above occurred, and maintain more accurate records of tampering events and corrective actions.

The one or more other sensors 226 can include any other sensor that can be used to obtain sensor data that can be used to corroborate any events or conditions detected based on data from any other sensors and/or further refine any events or conditions detected based on data from any other sensors. For example, the one or more other sensors 226 can include an image sensor with a different FOV and/or pose (and thus view) than the image sensor(s) 220, a different accelerometer and/or gyroscope (and/or IMU) placed in a different location/position than any accelerometer and/or gyroscope (and/or IMU) from the tamper detection sensor(s) 224 (if any), a different distance sensor (e.g., ultrasonic sensor, TOF sensor, RADAR sensor, LIDAR sensor, etc.) placed in a different position/location and/or otherwise having a different view than a distance sensor of the obstruction detection sensor(s) 222 (if any), an ambient light sensor to check for and/or manage ambient light levels to ensure the image sensor(s) 220 captures images with better light conditions, an infrared sensor, a microphone that can record audio used to detect events or conditions based on acoustic features in the audio, and/or any other sensor.

In some cases, the sensor systems 124 can optionally include other components. For example, the sensor systems 124 can optionally include a light source(s), such as a light bulb, lamp, or light-emitting diode (LED) used to emit light in the area to change the lighting conditions, which can affect the quality of the images captured by the image sensor(s) 220 and/or user access to the fire extinguisher 120. In another example, the sensor systems 124 can optionally include a motor(s) or actuator(s) that can be used to reposition any of the sensors of the sensor systems 124, the fire extinguisher 120, and/or any other component.

In some cases, the processing system 114 can use the data from the weight sensor(s) 118 and/or any of the sensor systems 124 to determine compliance information about the fire extinguisher 120. The compliance information can indicate whether the fire extinguisher 120 (including any conditions associated with the fire extinguisher 120 such as access conditions, pressure conditions, tampering conditions, fill conditions, weight conditions, and/or any other conditions) is compliant or noncompliant with any applicable rules or regulations.

In some cases, if the processing system 114 determines that the fire extinguisher 120 is non-compliant with a particular rule or regulation, the processing system 114 can communicate a report to a remote computer indicating which feature (or features) of the rule or regulation the fire extinguisher 120 has not passed. In response, the fire extinguisher 120 to properly assess and address the problem and implement any corrective action needed.

FIG. 3A is a diagram illustrating an example form factor 300 of the smart fire extinguisher installation system 110, according to some examples of the present disclosure. The example form factor 300 includes an example configuration of the smart assembly 112 and an example configuration of the smart mount 116. Here, the smart assembly 112 includes the processing system 114, which is housed within the smart assembly 112, and is coupled to a mechanical arm 312 (or rod). In some cases, the smart assembly 112 can include a tag 302 which can be used to access information associated with the fire extinguisher 120 such as, for example, inspection requirements associated with the fire extinguisher 120, records of previous inspections of the fire extinguisher 120, applicable rules or regulations, and/or other information associated with the fire extinguisher 120. In some cases, the tag 302 can include a code, such as a quick response (QR) code, that can be scanned by a camera device (e.g., any device that includes a camera, such as a smartphone, a laptop computer, a tablet computer, etc.) to retrieve the information associated with the fire extinguisher 120.

The mechanical arm 312 includes a case 314 on an end of the mechanical arm 312 opposite to an end of the mechanical arm 312 that is coupled to the smart assembly 112. The case 314 includes, contains, or is coupled to one or more sensors used to monitor the fire extinguisher 120. In this example, the case 314 includes, contains, or is coupled to the image sensor(s) 220 and the obstruction detection sensor(s) 222. In other cases, the case 314 may include, contain, or be coupled to the image sensor(s) 220 and one or more additional sensors, with or without the obstruction detection sensor(s) 222. In other cases, the case 314 may include, contain, or be coupled to the image sensor(s) 220 without the obstruction detection sensor(s) 222 and/or another sensor.

The mechanical arm 312 can be configured to extend forward relative to the smart assembly 112 to align the image sensor(s) 220 with the pressure gauge 122 of the fire extinguisher 120 when the fire extinguisher 120 is on the smart mount 116. The image sensor(s) 220 can be positioned within the case 314 based on an estimated alignment of the image sensor(s) 220 with the pressure gauge 122 of the fire extinguisher 120 when the fire extinguisher 120 is on the smart mount 116 and the mechanical arm 312 is in an extended position 318 where the mechanical arm 312 is extended forward relative to the smart assembly 112. Moreover, the length of the mechanical arm 312, the angle of the mechanical arm 312 relative to the smart assembly 112, the geometric shape (e.g., size, shape, etc.) and/or position of the case 314, and/or the position of the image sensor(s) 220 on the case 314 when the mechanical arm 312 is extended forward in front of the smart assembly 112 can be determined based on the FOV of the image sensor(s) 220 and the position of the pressure gauge 122 of the fire extinguisher 120 when the fire extinguisher 120 is on the smart mount 116.

For example, the position of the pressure gauge 122 of the fire extinguisher 120 when the fire extinguisher 120 is on the smart mount 116 and the FOV of the image sensor(s) 220 can be used to determine what position (e.g., orientation, location, distance, etc.) or range of positions of the image sensor(s) 220 (e.g., a position or range of positions in three-dimensional space and/or relative to the pressure gauge 122) would put the pressure gauge 122 within the FOV of the image sensor(s) 220 (e.g., would ensure that the pressure gauge 122 is within the FOV of the image sensor(s) 220) so the image sensor(s) 220 can capture images of the pressure gauge 122. The length and angle of the mechanical arm 312 when extended in the forward position, the position and/or geometric shape of the case 314, and the position (e.g., orientation, location, etc.) of the image sensor(s) 220 on the case 314 can be determined based on the position or range of positions of the image sensor(s) 220 determined to put the pressure gauge 122 within the FOV of the image sensor(s) 220.

To illustrate, the FOV of the image sensor(s) 220 and the position of the pressure gauge 122 of the fire extinguisher 120 when the fire extinguisher 120 is on the smart mount 116 can be used to determine where the image sensor(s) 220 can be positioned relative to the position of the pressure gauge 122 (e.g., what orientation, distance, and location relative to the position of the pressure gauge 122) so the pressure gauge 122 is within the FOV of the image sensor(s) 220 when the mechanical arm 312 is extended in the forward position, in order to allow the image sensor(s) 220 to capture images of the pressure gauge 122. The determined position of the image sensor(s) 220 can be used to determine the length and angle of the mechanical arm 312 when extended in the forward position and the placement of the image sensor(s) 220 on the case 314 to ensure that, when the mechanical arm 312 is extended in the forward position and the fire extinguisher 120 is on the smart mount 116, the pressure gauge 122 will be within the FOV of the image sensor(s) 220 to allow the image sensor(s) 220 to capture images of the pressure gauge 122. Thus, the length and angle of the mechanical arm 312 when extended in the forward position, the FOV of the image sensor(s) 220, and the position of the image sensor(s) 220 on the case 314 can be designed to align the image sensor(s) 220 with the pressure gauge 122 when the mechanical arm 312 is extended in the forward position and the fire extinguisher 120 is on the smart mount 116, to ensure that the pressure gauge 122 will be within the FOV of the image sensor(s) 220 so the image sensor(s) 220 can capture images of the pressure gauge 122.

The images of the pressure gauge 122 captured by the image sensor(s) 220 can be used to detect a pressure level of the fire extinguisher 120 by detecting the pressure gauge 122 depicted in the images and classifying the pressure reading of the pressure gauge 122 as depicted in the images. In some cases, the images of the pressure gauge 122 captured by the image sensor(s) 220 can additionally be used to determine whether the fire extinguisher 120 is on the smart mount 116 or has been removed from the smart mount 116. For example, assume that the mechanical arm 312 and the position of the image sensor(s) 220 on the case 314 are configured and/or calibrated to ensure that the pressure gauge 122 is within the FOV of the image sensor(s) 220 when the fire extinguisher 120 is on the smart mount 116 and the mechanical arm 312 is extended in the forward position. If the image sensor(s) 220 captures an image while the mechanical arm 312 is extended in the forward position and the pressure gauge 122 is not detected in the image, the failure to detect the pressure gauge 122 in the image can indicate that the fire extinguisher 120 is not on the smart mount 116. This way, the images captured by the image sensor(s) 220 can be used to determine if the fire extinguisher 120 is on the smart mount 116 or has been removed.

When the mechanical arm 312 is extended in the forward position, the mechanical arm 312 can place the obstruction detection sensor(s) 222 in a position relative to the fire extinguisher 120 that would allow the obstruction detection sensor(s) 222 to detect objects and/or take distance measurements of objects positioned in front of the fire extinguisher 120 (e.g., on a side of the fire extinguisher 120 opposite to the side of the fire extinguisher 120 facing the smart assembly 112 and smart mount 116 when the fire extinguisher 120 is on the smart mount 116), if any. The data from the obstruction detection sensor(s) 222 can then be used to determine whether there are any physical obstructions within an access area near the fire extinguisher 120 that can be used by users to access the fire extinguisher 120. In some examples, determinations whether there are physical obstructions within the access area can be based on applicable rules or regulations that define the access area that needs to be free from obstructions and/or that provides parameters used to determine whether something constitutes an obstruction, such as a minimum size of an obstruction, a shape(s) of an obstruction, a relative distance of an obstruction (which may or may not depend on the size of obstruction), a relative orientation of the obstruction, and/or any other information that can be used to determine what area(s) relative to the fire extinguisher 120 should be free from obstructions and/or what may be classified as an obstruction under the relevant rules or regulations.

For example, the relevant rules or regulations may specify that an object the size of a bottle cap located within a certain distance from the fire extinguisher 120 does not constitute an obstruction, but a chair of a certain size located within a certain distance from the fire extinguisher 120 does constitute an obstruction under the rules or regulations. Thus, if the obstruction detection sensor(s) 222 detects an object within a distance from the fire extinguisher 120, the information from the rules or regulations can be used to determine whether the object constitutes an obstruction given the size of the object, the shape of the object, the position of the fire extinguisher 120, and/or the position of the object relative to the position of the fire extinguisher 120.

In some examples, the mechanical arm 312 can move relative to the smart assembly 312 as needed. For example, the mechanical arm 312 can move between the extended position 318 and a different position 316. In some cases, the different position 316 can include a position implemented when the image sensor(s) 220 is not in use. In some cases, the mechanical arm 312 can include a hinge 310 that allows the mechanical arm 312 to be moved between the extended position 318 and the different position 316. In some aspects, the mechanical arm 312 can be manually moved between the extended position 318 and the different position 316. For example, a user can manually move the mechanical arm 312 to the extended position 318 as needed to place the pressure gauge 122 within the FOV of the image sensor(s) 220 so the image sensor(s) 220 can capture images of the pressure gauge 122.

In other aspects, the mechanical arm 312 can additionally or alternatively be automatically moved by a motor or actuator (not shown) on the smart assembly 112 as needed to allow the image sensor(s) 220 to capture images of the pressure gauge 122. For example, the smart assembly 112 can include a motor or actuator configured to move the mechanical arm 312 between the extended position 318 and the different position 316. The processing system 114 on the smart assembly 112 can send a signal to the motor or actuator to trigger the motor or actuator to move the mechanical arm 312 as needed to or from the extended position 318. For example, the processing system 114 may be configured to trigger the image sensor(s) 220 to capture images at a specific interval. In this example, before the processing system 114 triggers the image sensor(s) 220 to capture images, the processing system 114 can trigger the motor or actuator to move the mechanical arm 312 to the extended position 318. Once the mechanical arm 312 is in the extended position 318, the processing system 114 can trigger the image sensor(s) 220 to capture images, so the image sensor(s) 220 is aligned with the pressure gauge 122 if the fire extinguisher 120 is on the smart mount 116, such that the images will depict the pressure gauge 122.

The smart mount 116 in this example includes prongs 304 and 306 used to hold the fire extinguisher 120. The prong 304 and/or the prong 306 can include the weight sensor(s) 118 to measure a force applied by a weight (if any) on the prong 304 and/or the prong 306 (e.g., when the fire extinguisher 120 is on the smart mount 116). In some cases, each prong can include a weight sensor. In other cases, only one prong may include a weight sensor. As previously explained, in some examples, the weight sensor(s) 118 can represent one or more strain gauges. Each of the one or more strain gauges can include one or more wires placed on a respective prong of the smart mount 116. The one or more wires can measure changes in electrical properties (e.g., resistance, voltage, or current) of the one or more wires when a mechanical force from a weight (e.g., from a weight of the fire extinguisher 120) is applied on the one or more wires. The changes in electrical properties can be caused by strain on or bending of the one or more wires caused by the mechanical force from the weight. Moreover, the changes in electrical properties can be converted to a weight to determine a weight (or lack thereof) applied on the smart mount 116.

The prongs 304 and 306 of the smart mount 116 can be configured to hold the fire extinguisher 120 as previously explained, and can allow the fire extinguisher 120 to be removed from the smart mount 116 when needed. For example, if there is a fire emergency, a user can remove the fire extinguisher 120 from the smart mount 116 to use the fire extinguisher 120 to help extinguish or control the fire.

For example, with reference to FIG. 3B, the fire extinguisher 120 can be placed on the smart mount 116 and held in place by the prongs 304 and 306 of the smart mount 116. When the mechanical arm 312 is in the extended position 318, the image sensor(s) 220 is positioned relative to the pressure gauge 122 such that pressure gauge 122 is within the FOV of the image sensor(s) 220, which allows the image sensor(s) 220 to capture images of the pressure gauge 122 while the fire extinguisher 120 is on the smart mount 116 and the mechanical arm 312 is in the extended position 318. The weight sensor(s) 118 on the prong 304 of the smart mount 116 can measure a weight applied on the prong 304 and weight sensor(s) 118 by the fire extinguisher 120, and provide the weight measurement to the processing system 114 in the smart assembly 112.

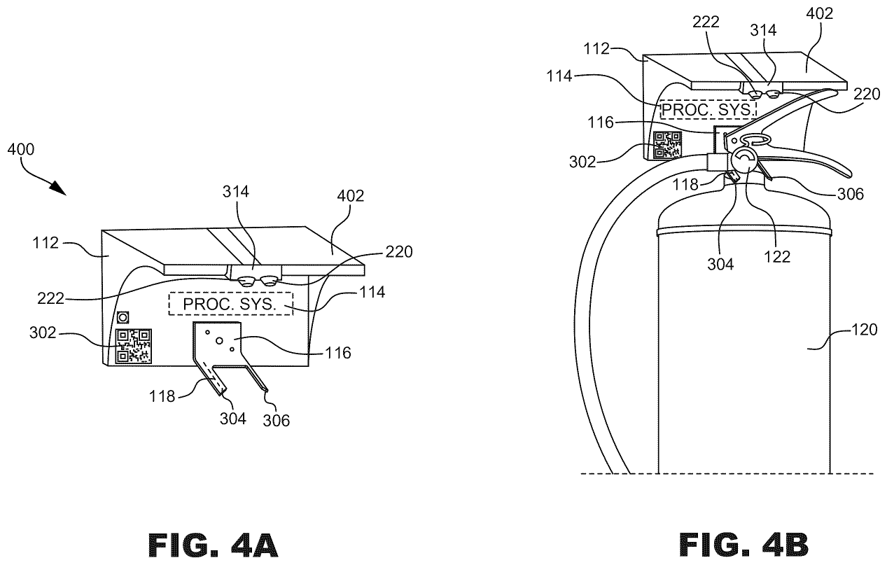

FIG. 4A is a diagram illustrating another example form factor 400 of the smart fire extinguisher installation system 110, according to some examples of the present disclosure. In this example, the smart mount 116 is coupled to the smart assembly 112, and the smart assembly 112 includes a canopy 402 or includes a portion shaped as a canopy 402. The canopy 402 extends forward relative to the rest of the smart assembly 112 such that at least a portion of the canopy 402 is above the pressure gauge 122 when the fire extinguisher 120 is on the smart mount 116. The canopy 402 can include the case 314 with the image sensor(s) 220 and optionally the object detection sensor(s) 222 (and/or any other sensor).

In some examples, the case 314 can be attached to an edge of the canopy 402 such that the image sensor(s) 220 on the case 314 is aligned with the pressure gauge 122 when the fire extinguisher 120 is on the smart mount 116. The height, shape, angle, and/or the length of the canopy 402 (e.g., the length in which the canopy 402 extends forward relative to the rest of the smart assembly 112) can be determined based on the position of the pressure gauge 122 when the fire extinguisher 120 is on the smart mount 116 and the FOV of the image sensor(s) 220.

For example, as previously described, the position of the pressure gauge 122 when the fire extinguisher 120 is on the smart mount 116 and the FOV of the image sensor(s) 220 can be used to determine a pose (e.g., orientation, location, distance, etc.) of the image sensor(s) 220 relative to the position of the pressure gauge 122 that would put the pressure gauge 122 within the FOV of the image sensor(s) 220 to allow the image sensor(s) 220 to capture images of the pressure gauge 122. The pose of the image sensor(s) 220 needed to put the pressure gauge 122 within the FOV of the image sensor(s) 220 can then be used to determine the shape, size, and/or configuration of the canopy 402 and the position of the case 314 and the image sensor(s) 220 on the canopy 402 to ensure that the canopy 402 and the case 314 place the image sensor(s) 220 in a position to allow the image sensor(s) 220 to capture images of the pressure gauge 122 when the fire extinguisher 120 is on the smart mount 116.

Moreover, in the example form factor 400, the smart mount 116 is mounted on or attached to a portion of the smart assembly 112 that is below the edge or portion of the canopy 402 where the case 314 and the image sensor(s) 220 are positioned. For example, the smart mount 116 can be mounted or attached to bottom portion of the smart assembly 112 that is below the canopy 402 when the smart assembly 112 and the smart mount 116 are mounted on or secured to a structure (e.g., a wall, etc.), such as structure 104 shown in FIG. 1.

In some cases, the smart mount 116 can be mounted on or attached to the smart assembly 112, and the smart assembly 112 can be mounted on or attached to a structure, such as the structure 104 shown in FIG. 1, such that the fire extinguisher 120 can be placed on the smart mount 116 and held in place by the smart assembly 112 and smart mount 116 while the smart assembly 112 is mounted on or attached to the structure. In other cases, the smart assembly 112 can be mounted on or attached to the structure, and the smart mount 116 can be mounted on or attached to a portion of the structure below the smart assembly 112 (e.g., rather than mounting or attaching the smart mount 116 on/to the smart assembly 112).

For example, with reference to FIG. 4B, the smart mount 116 can be coupled to the smart assembly 112, and the smart assembly 112 can be coupled to a structure, such as a wall or beam. The fire extinguisher 120 can be placed on the smart mount 116, which can hold the extinguisher 120 in place using the prongs 304 and 306 of the smart mount 116. The canopy 402 can extend above and in front of the pressure gauge 122 (e.g., relative to a side of the pressure gauge 122 that displays a pressure reading/level) so the image sensor(s) 220 on the case 314 coupled to the canopy 402 can capture images of the pressure gauge 122, as the canopy 402 and the case 314 are configured to position the image sensor(s) 220 such that the pressure gauge 122 is within the FOV of the image sensor(s) 220 when the fire extinguisher 120 is on the smart mount 116. As previously described, the prong 304 and/or the prong 306 can include the weight sensor(s) 118, which can take weight measurements and send the weight measurements to the processing system 114 housed in the smart assembly 112.

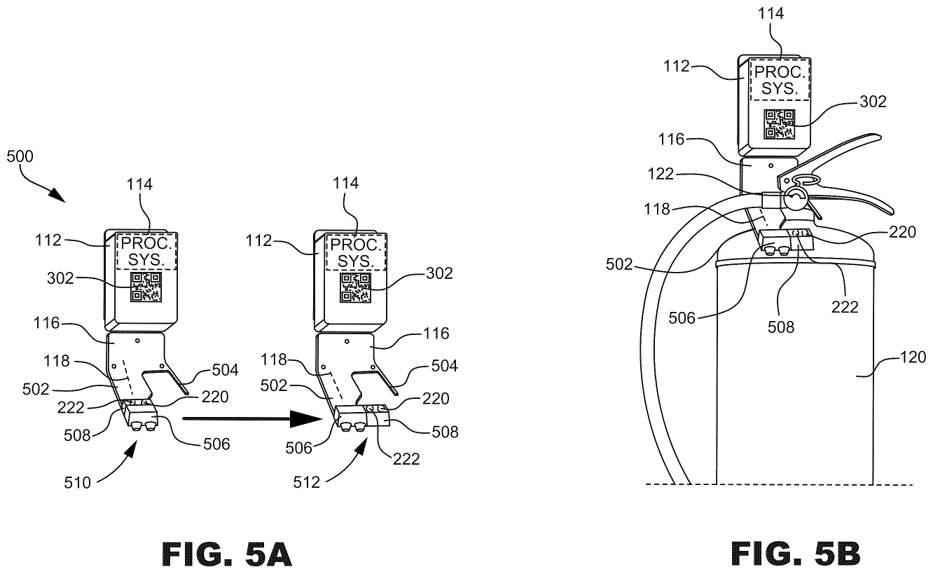

FIG. 5A is a diagram illustrating another example form factor 500 of the smart fire extinguisher installation system 110, according to some examples of the present disclosure. In this example, the smart mount 116 has a two-pronged configuration, with a prong 502 and a prong 504 used to hold the fire extinguisher 120 when the fire extinguisher 120 is placed on the smart mount 116. The prong 502 includes the weight sensor(s) 118, which can obtain weight measurements and send the weight measurements to the processing system 114 housed by the smart assembly 112. The smart assembly 112 and the smart mount 116 can be part of a same unit, or separate units. The smart assembly 112 can be mounted to a structure as previously described. The smart mount 116 can be mounted or attached to the smart assembly 112, or can be mounted or attached to the same structure as the smart assembly 112 such that the smart mount 116 is placed below the smart assembly 112.

As shown, the prong 502 is coupled to a sensor case 506 used to house or host the image sensor(s) 220 and optionally the obstruction detection sensor(s) 222 (and/or any other sensor). The image sensor(s) 220 (and optionally the obstruction detection sensor(s) 222 and/or any other sensor) can be housed or hosted on/by a portion 508 of the case 506 that can be moved between a disengaged position 510 and an engaged position 512. For example, when the fire extinguisher 120 is not on the smart mount 116, the portion 508 of the sensor case 506 including the image sensor(s) 220 can be placed in the disengaged position 510 where the portion 508 of the sensor case 506 is placed within or along a plane or axis of the prong 502 and away from the other prong 504, in order to allow the fire extinguisher 120 to be placed within the prong 502 and the prong 504 when mounting the fire extinguisher 120.

When the fire extinguisher 120 is placed on the smart mount 116, the portion 508 of the sensor case 506 can be placed in the engaged position 512. The portion 508 of the sensor case 506 can be placed in the engaged position 512 by flipping or switching the portion 508 of the sensor case 506 towards the other prong 504 so that a surface of the portion 508 of the sensor case 506 that includes the image sensor(s) 220 faces towards the smart assembly 112 and the fire extinguisher 120 when placed on the smart mount 116, thereby pointing the image sensor(s) 220 toward the smart assembly 112 and the pressure gauge 122 when the fire extinguisher 120 is mounted. This way, when the portion 508 of the sensor case 506 is in the engaged position 512, the image sensor(s) 220 can be positioned relative to the pressure gauge 122 such that the pressure gauge 122 is within the FOV of the image sensor(s) 220.

For example, with reference to FIG. 5B, when the portion 508 of the sensor case 506 containing the image sensor(s) 220 is in the engaged position 512, the image sensor(s) 220 can face the pressure gauge 122 and can capture images of the location where the pressure gauge 122 is or would be when the fire extinguisher 120 is placed on the smart mount 116. Thus, if the fire extinguisher 120 is on the smart mount 116 and the portion 508 of the sensor case 506 is in the engaged position 512, the image sensor(s) 220 can capture images of the pressure gauge 122, which can be used to detect a presence of the fire extinguisher 120 and/or a pressure level of the fire extinguisher 120, as further described herein.

On the other hand, if the fire extinguisher 120 is not on the smart mount 116, the images captured by the image sensor(s) 220 when the portion 508 of the sensor case 506 is in the engaged position 512 will not depict the pressure gauge 122, which indicates that the fire extinguisher 120 is not on the smart mount 116 (e.g., has been removed from the smart mount 116). Thus, the processing system 114 can use any images captured by the image sensor(s) 220 while the portion 508 of the sensor case 506 is in the engaged position 512 to detect whether the fire extinguisher 120 is on the smart mount 116 or has been removed from the smart mount 116.

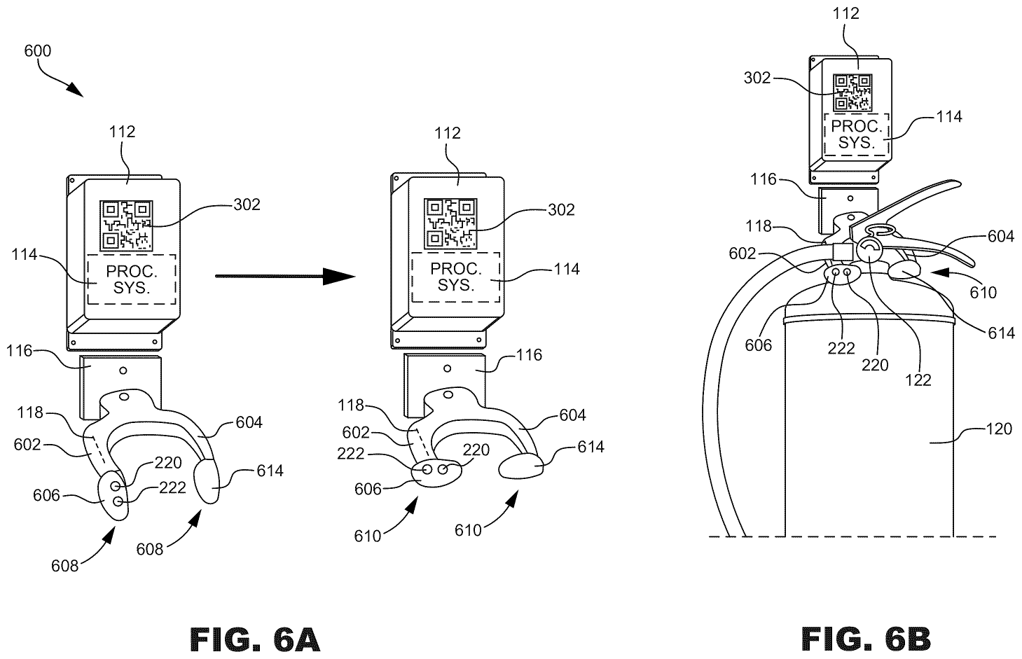

FIG. 6A is a diagram illustrating another example form factor 600 of the smart fire extinguisher installation system 110, according to some examples of the present disclosure. In this example, the smart mount 116 can include a two-prong configuration, including a prong 602 that includes the weight sensor(s) 118 and a sensor module 606, and another prong 604 used to secure the fire extinguisher 120 in place along with the prong 602. The sensor module 606 can include the image sensor(s) 220 and can optionally include the obstruction detection sensor(s) 222 and/or any other sensor. In some cases, the sensor module 606 can include or have a portion that is shaped as a paddle, panel, or plate that can help secure the fire extinguisher 120 in place. The other prong 604 can also include an end 614 that includes or is shaped as a paddle, panel, or plate, and can be used to secure the fire extinguisher 120.

When the fire extinguisher 120 is not on the smart mount 116 or is removed from the smart mount 116, the sensor module 606 and the end 614 of the other prong 604 can be moved, switched, or flipped to an open position 608. The open position 608 can allow the fire extinguisher 120 to be inserted into the prongs 602 and 604 of the smart mount 116 or removed from the smart mount 116. When the fire extinguisher 120 is placed on the smart mount 116, the sensor module 606 and the end 614 of the other prong 604 can be moved or flipped, or switched to a closed position 610. When in the closed position 610, the sensor module 606 (and/or an end of the sensor module 606) can be flipped or moved in a direction towards the other prong 604 and the end 614 of the other prong 604, and the end 614 (and/or a portion of the end 614) of the other prong 604 can be flipped or moved in a direction towards the prong 602 and the sensor module 606. This way, the sensor module 606 and the end 614 of the other prong 604 can reduce the gap between each other to at least partially close the opening of the smart mount 116 between the sensor module 606 and the end 614 of the other prong 604 to help secure the fire extinguisher 120 when placed on the smart mount 116.

In some cases, the sensor module 606 can be coupled to the prong 602 via a hinge or movable mechanism that allows the sensor module 606 to be moved, switched, or flipped between the open position 608 and the closed position 610. Similarly, the end 614 of the other prong 604 can be coupled to the other prong 604 via a hinge or movable mechanism that allows the end 614 to be moved, switched, or flipped between the open position 608 and the closed position 610. In some cases, the sensor module 606 and the end 614 of the other prong 604 can be manually moved, switched, or flipped by a user between the open position 608 and the closed position 610 as needed. In some aspects, the sensor module 606 and the end 614 of the other prong 604 can additionally or alternatively be moved, switched, or flipped between the open position 608 and the closed position 610 by a motor(s) or actuator(s). The motor(s) or actuator(s) can be controlled by the processing system 114 on the smart assembly 112.

For example, the processing system 114 can send a signal to the motor(s) or actuator(s) configured to trigger the motor(s) or actuator(s) to move, switch, or flip the sensor module 606 and the end 614 of the other prong 604 from the open position 608 to the closed position 610, and vice versa. The processing system 114 can send such signals to the motor(s) or actuator(s) in response to a user input or request, in response to a triggering event (e.g., a detected condition, a detected emergency, activation or pressing of a button, etc.), according to a schedule, at certain intervals, and/or based on any other schedule or factor. For example, the processing system 114 can be configured to send a signal to the motor(s) or actuator(s) at a certain interval, such as weekly or monthly, or on a particular schedule. The signal can then trigger the motor(s) or actuator(s) to move, switch, or flip the sensor module 606 and the end 614 of the other prong 604 as previously described.

In some cases, the sensor module 606 and the end 614 of the other prong 604 can be configured to automatically move, switch, or flip to the closed position 610 when the fire extinguisher 120 is placed on the smart mount 116. For example, the smart mount 116, the prong 602, and/or the sensor module 606 can include a release mechanism that automatically snaps the sensor module 606 into position (e.g., from the open position 608 to the closed position 610) when the fire extinguisher 120 is placed on the smart mount 116. The release mechanism can include one or more springs or another (similar) mechanical release mechanism (e.g., a pin, fastener, switch, etc.). The release mechanism (e.g., spring(s) or other mechanical mechanism) can automatically flip the sensor module 606 into the closed position 610 in response to a load/weight (e.g., a load/weight of the fire extinguisher 120) applied to the smart mount 116, the prong 602, and/or the sensor module 606. In other words, the weight of the fire extinguisher 120 when the fire extinguisher 120 is placed on the smart mount 116 can trigger the release mechanism to release its mechanical energy and snap the sensor module 606 into the closed position 610. For example, if the release mechanism includes a spring, the weight of the fire extinguisher 120 when the fire extinguisher 120 is placed on the smart mount 116 can trigger the spring to release its mechanical energy by stretching or compressing, and thereby snap the sensor module 606 into the closed position 610.

Similarly, the smart mount 116, the other prong 604, and/or the end 614 of the other prong 604 can include a release mechanism, such as a spring, that automatically snaps the end 614 of the other prong 604 into position (e.g., from the open position 608 to the closed position 610) when the fire extinguisher 120 is placed on the smart mount 116. The release mechanism (e.g., a spring(s) or other mechanical mechanism) can automatically flip the end 614 of the other prong 604 into the closed position 610 in response to a load/weight (e.g., a load/weight of the fire extinguisher 120) applied to the smart mount 116, the prong 604, and/or the end 614 of the other prong 604. For example, if the release mechanism includes a spring, the weight of the fire extinguisher 120 when the fire extinguisher 120 is placed on the smart mount 116 can trigger the spring to release its mechanical energy by stretching or compressing, and thereby snap the end 614 of the other prong 604 into the closed position 610.

The smart mount 116 can be part of or coupled to the smart assembly 112, or can be separate from the smart assembly 112. If the smart mount 116 is a separate unit from the smart assembly 112, the smart mount 116 can be coupled to the smart assembly 112 when the smart assembly 112 and the smart mount 116 are setup for use to mount the fire extinguisher 120, or can be separately coupled to the same structure as the smart assembly 112. Once the smart assembly 112 and the smart mount 116 are mounted to a structure (e.g., either as a single unit or as separate units), the fire extinguisher 120 can be placed on the smart mount 116 (e.g., within the prong 602 and the other prong 604). Once the fire extinguisher 120 is on the smart mount 116 and held between the prong 602 and the other prong 604, the sensor module 606 and the end 614 of the other prong 604 can be moved, switched, or flipped to the closed position 610 to secure the fire extinguisher 120 in place and align the image sensor(s) 220 on the sensor module 606 with the pressure gauge 122 to ensure that the pressure gauge 122 is within the FOV of the image sensor(s) 220 so the image sensor(s) 220 can capture images of the pressure gauge 122 as needed. When removing the fire extinguisher 120 from the smart mount 116, the sensor module 606 and the end 614 of the other prong 604 can be moved, switched, or flipped to the closed position 608, which allows or facilitates removal of the fire extinguisher 120 from the smart mount 116.

For example, as shown in FIG. 6B, when the fire extinguisher 120 is placed on the smart mount 116, the fire extinguisher 120 can be held in place by the prong 602 and the other prong 604 and secured by moving, switching, or flipping the sensor module 606 and the end 614 of the other prong 604 to the closed position 610. As shown, when the sensor module 606 is in the closed position 610, the sensor module 606 can be positioned such that the image sensor(s) 220 on the sensor module 606 has a view of and/or line-of-sight to the pressure gauge 122, so the image sensor(s) 220 can capture images of the pressure gauge 122 while the fire extinguisher 120 is on the smart mount 116. In other words, when the sensor module 606 is in the closed position 610, the sensor module 606 can be positioned such that the pressure gauge 122 is within the FOV of the image sensor(s) 220 on the sensor module 606, which allows the image sensor(s) 220 to capture images of the pressure gauge 122 for monitoring as described herein.

The size, shape, angle, and/or other pose parameters of the prong 602, the prong 604, and the sensor module 606 can be designed to ensure that the image sensor(s) 220 on the sensor module 606 has a view to the pressure gauge 122 when the fire extinguisher 120 is on the smart mount 116. For example, when designing the smart mount 116 and the smart assembly 112 according to the example form factor 600, the manufacturer can determine relative poses of the image sensor(s) 220 and the pressure gauge 122 on the fire extinguisher 120 that would position the pressure gauge 122 within the FOV of the image sensor(s) 220. The relative poses of the image sensor(s) 220 and the pressure gauge 122 can represent the relative positions of the image sensor(s) 220 on the sensor module 606 and the pressure gauge 122 when the sensor module 606 is in the closed position 610 and the fire extinguisher 120 is on the smart mount 116. The relative positions of the image sensor(s) 220 and the pressure gauge 122 can be used to determine a length of the prongs 602 and 604, a distance between the prongs 602 and 604, an angle of the prongs 602 and 604, a size and/or pose (e.g., orientation, location, etc.) of the sensor module 606, and/or a position of the image sensor(s) 220 on the sensor module 606.

The length of the prongs 602 and 604, the distance between the prongs 602 and 604, the angle of the prongs 602 and 604, a size and/or pose (e.g., orientation, location, etc.) of the sensor module 606, and/or the position of the image sensor(s) 220 on the sensor module 606 can be calculated to place the image sensor(s) 220 and the pressure gauge 122 in the relative positions determined to allow the image sensor(s) 220 to capture images of the pressure gauge 122 when the fire extinguisher 120 is on the smart mount 116. This way, when the fire extinguisher 120 is on the smart mount 116 and the sensor module 606 is in the closed position 610, the image sensor(s) 220 on the sensor module 606 can have a view to the pressure gauge 122 to allow the image sensor(s) 220 to capture images of the pressure gauge 122 and/or to capture images of the location/area where the pressure gauge 122 is expected to be when the fire extinguisher 120 is on the smart mount 116 so that the images can be used to detect whether the fire extinguisher 120 has been removed from the smart mount 116.

For example, if the processing system 114 performs object detection (e.g., via the software model(s) 210) on an image captured by the image sensor(s) 220 and determines that the image does not depict the pressure gauge 122, the processing system 114 can determine that the fire extinguisher 120 is not on the smart mount 116 (e.g., has been moved/removed from the smart mount 116) based on the failure to detect the pressure gauge 122 in the image. The processing system 114 can determine that the fire extinguisher 120 is not on the smart mount 116 based on the image because the image sensor(s) 220 is configured to have a view or line-of-sight to the pressure gauge 122 when the sensor module 606 is in the closed position 610. Thus, a failure to detect the pressure gauge 122 in an image captured by the image sensor(s) 220 can indicate that the fire extinguisher 120 (and thus the pressure gauge 122) is not on the smart mount 116.

FIG. 7A is a diagram illustrating an example smart fire extinguisher installation system 110 that includes an example cabinet 700, according to some examples of the present disclosure. The cabinet 700 can be used to store the fire extinguisher 120 in an easily accessible manner. The cabinet 700 can be mounted, attached, or otherwise coupled to a structure (e.g., structure 104), such as a wall or beam. The cabinet 700 can include a box 702, which can be used to store the fire extinguisher 120 within the cabinet 700. The box 702 can include the smart assembly 112, which can include/contain or house the processing system 114, and the smart mount 116. In some cases, the box 702 can optionally include one or more sensors, such as one or more sensors from the sensor systems 114.

The fire extinguisher 120 can be stored in the cabinet 700 by placing the fire extinguisher 120 on the smart mount 116 located inside of the box 702 of the cabinet 700. The smart mount 116 can include a hook or prong, a bracket, a multi-prong configuration, or any other type of fire extinguisher mount or fastener. In the example shown in FIG. 7A, the smart mount 116 has a dual-prong configuration. In particular, the smart mount 116 shown in FIG. 7A includes prong 706 and prong 708 used to hold the fire extinguisher 120 in place, and the prong 706 includes a weight sensor(s) 118. However, in other examples, the prong 708 can additionally or alternatively include the weight sensor(s) 118.

The weight sensor(s) 118 can measure a weight/load on the weight sensor(s) 118 and the prong 706 and/or 708, and communicate the weight measurement to the processing system 114 housed within the smart assembly 112. The processing system 114 can send signals to the weight sensor(s) 118 configured to trigger the weight sensor(s) 118 to obtain weight measurements. In some examples, the processing system 114 can trigger the weight sensor(s) 118 to obtain weight measurements at specific time intervals, according to a specific schedule, in response to a particular event (e.g., a user input, a monitoring event, an emergency event, etc.), and/or in response to any trigger.

The cabinet 700 can include a door 704 that can be closed to protect the fire extinguisher 120 when the fire extinguisher 120 is in the box 702 and on the smart mount 116, and can be opened to place the fire extinguisher 120 on the smart mount 116 or remove it from the smart mount 116. The door 704 can include the image sensor 220, which can be used to capture images of the pressure gauge 122 when the fire extinguisher 120 is in the box 702. The image sensor 220 can be attached, secured, fastened, or otherwise coupled to a side (e.g., a face) of the door 704 and facing towards the pressure gauge 122 so the image sensor 220 can have a view and capture images of the pressure gauge 122 when the fire extinguisher 120 is in the box 702. In some cases, the image sensor 220 can be located on an interior side of the door 704 so that the image sensor 220 has a view of the pressure gauge 122 when the fire extinguisher 120 is in the box 702 and can capture images of the pressure gauge 122. In other cases, the door 704 (or a portion of the door 704 where the image sensor 220 is placed) can be made of a material, such as glass or any transparent material, that allows the image sensor 220 to image the pressure gauge 122 even if the image sensor 220 is placed on exterior side of the door 704. In such cases, the image sensor 220 can be placed on the interior or exterior side of the door 704 and can have a view and capture images of the pressure gauge 122 regardless of whether the image sensor 220 is placed on an interior or exterior side of the door 704.

The image sensor 220 can be coupled to a side of the door 704 using any coupling mechanism such as, for example and without limitation, using adhesive or glue, a fastener, one or more screws or nails, a pin, a bracket, a magnet (or magnetic coupling mechanism), and/or any other mechanical coupling or fastening mechanism.

In some examples, the position/pose (e.g., height, orientation, location, etc.) of the image sensor(s) 220 within a side of the door 704 can be determined based on the FOV of the image sensor(s) 220, the position/pose of the smart mount 116 within the box 702, and/or the estimated position/pose of the pressure gauge 122 when the fire extinguisher 120 is on the smart mount 116 inside of the box 702. For example, the image sensor(s) 220 can be positioned within a side of the door 704 in a particular location such that the pressure gauge 122 is within the FOV of the image sensor(s) 220 when the fire extinguisher 120 is placed on the smart mount 116 and the door 704 is closed or the door 704 is opened by less than a threshold amount (e.g., when an angle of the door 704 is within a threshold angle or range of angles). This way, when the fire extinguisher 120 is on the smart mount 116 and the door 704 is closed (or open within a threshold angle or range of angles), the image sensor(s) 220 is aligned with the pressure gauge 122 and/or has a view of the pressure gauge 122 so that the image sensor(s) 220 can capture images of the pressure gauge 122.

In some cases, the box 702 and/or the door 704 of the cabinet 700 can include one or more additional sensors. For example, in some cases, the obstruction detection sensor(s) 222 and/or the tamper detection sensor(s) 224 can be coupled to, attached to, fastened to, mounted on, or secured to an outer side or surface of the door 704 such that the obstruction detection sensor(s) 222 and/or the tamper detection sensor(s) 224 can each obtain measurements of an area outside of the cabinet 700. The measurements can be used to detect certain conditions and/or events associated with the fire extinguisher 120, such as obstructions, tampering conditions/events, environmental conditions, etc. The processing system 114 can receive any measurements obtained by the obstruction detection sensor(s) 222 and/or the tamper detection sensor(s) 224, and can trigger the obstruction detection sensor(s) 222 and/or the tamper detection sensor(s) 224 to obtain measurements. The processing system 114 can trigger the obstruction detection sensor(s) 222 and/or the tamper detection sensor(s) 224 to obtain measurements at certain time intervals, according to a schedule, in response to certain events (e.g., signals, user inputs, detection events, etc.), and/or in response to any other triggers.

While the obstruction detection sensor(s) 222 and the tamper detection sensor(s) 224 are coupled to the door 704 in FIG. 7A, in other examples, the obstruction detection sensor(s) 222 and/or the tamper detection sensor(s) 224 can be coupled to any other portion of the cabinet 700, such as an exterior of the box 702, an edge of the box 702 (e.g., a bottom edge of the box 702 that is below the door 704 and on the side of the door 704, a top edge of the box 702 that is above the door 704 and on the side of the door 704, and/or any other edge of the box 702), a top of the box 702, and/or any other portion of the cabinet 700. In some cases, the door 704 (e.g., an interior and/or an exterior of the door 704) can include any other sensors (e.g., the one or more other sensors 226), such as an ambient light sensor, an additional image sensor, an infrared sensor, a microphone, etc. Moreover, the box 702 can include or house any other components, such as a light emitting device (e.g., a lamp/bulb, an LED, etc.) that can increase the light levels around the image sensor(s) 220 to increase the brightness levels of images captured by the image sensor(s) 220 and/or allow the image sensor(s) 220 to use lower exposure settings to capture images, a power supply, a speaker device, a recording device, tools such as emergency tools, a portable computing device, a display, a network device, an antenna, and/or any other device.

FIG. 7B illustrates another example configuration 750 of the smart mount 116, according to some examples of the present disclosure. As shown, the example configuration 750 of the smart mount 116 includes a single-prong configuration. In particular, the smart mount 116 includes a prong 720, which in this example is shaped as a hook. The prong 720 can be used to mount fire extinguishers that include a ring 722 for receiving the prong 720, as shown in FIG. 7B.

For example, to secure the fire extinguisher 120 to the smart mount 116, the prong 720 can be inserted into the ring 722 on the fire extinguisher 120. When the prong 720 is inserted into the ring 722, the prong 720 and the ring 722 can secure the fire extinguisher 120 in place. The smart mount 116 can be mounted on a structure (e.g., structure 104), such as a wall or beam, using any mounting or coupling mechanism such as, for example, a screw(s), nail(s), pin(s), board(s), fastener(s), and/or any other coupling mechanism. When the smart mount 116 is mounted on the structure, the fire extinguisher 120 can be mounted on the smart mount 116 as described above to retain the fire extinguisher 120 in place.

The prong 720 can also include the weight sensor(s) 118, which can obtain weight measurements used to determine a weight and/or fill of the fire extinguisher 120, as further described herein. In some cases, the weight measurements can additionally or alternatively be used to determine whether the fire extinguisher 120 is on the smart mount 116 or has been moved/removed. For example, if the weight sensor(s) 118 does not detect any weight on the smart mount 116 or the weight measurement from the weight sensor(s) 118 is below a threshold, the processing system 114 (or the remote management system 150) can determine that the fire extinguisher 120 is not on the smart mount 116 or has been moved/removed from the smart mount 116.

The smart mount 116 with the example configuration 750 can be used with any cabinet or smart assembly 112 described herein. For example, the smart mount 116 with the example configuration 750 can be included in the box 702 of the cabinet 700 to mount the fire extinguisher 120 within the cabinet 700, as previously described. As another example, the smart mount 116 with the example configuration 750 can be used with the smart assembly 112 shown in FIGS. 3A, 4A, 5A, 6A, and/or any other smart assembly. In other words, the smart mount 116 with the example configuration 750 can be used as the smart mount implemented with the form factor 300 of the smart fire extinguisher installation system 110 shown in FIG. 3A, the form factor 400 of the smart fire extinguisher installation system 110 shown in FIG. 4A, the form factor 500 of the smart fire extinguisher installation system 110 shown in FIG. 5A, the form factor 600 of the smart fire extinguisher installation system 110 shown in FIG. 6A, and/or any other form factor of the smart fire extinguisher installation system 110.

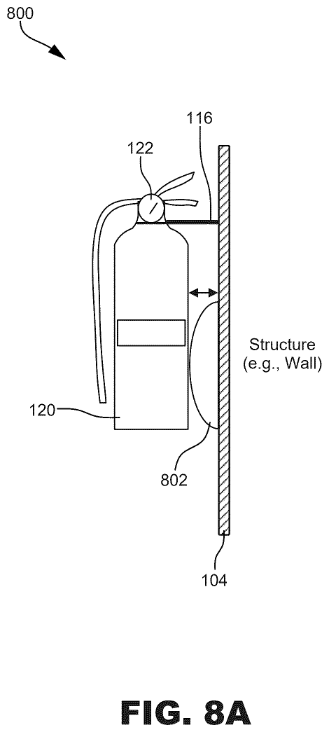

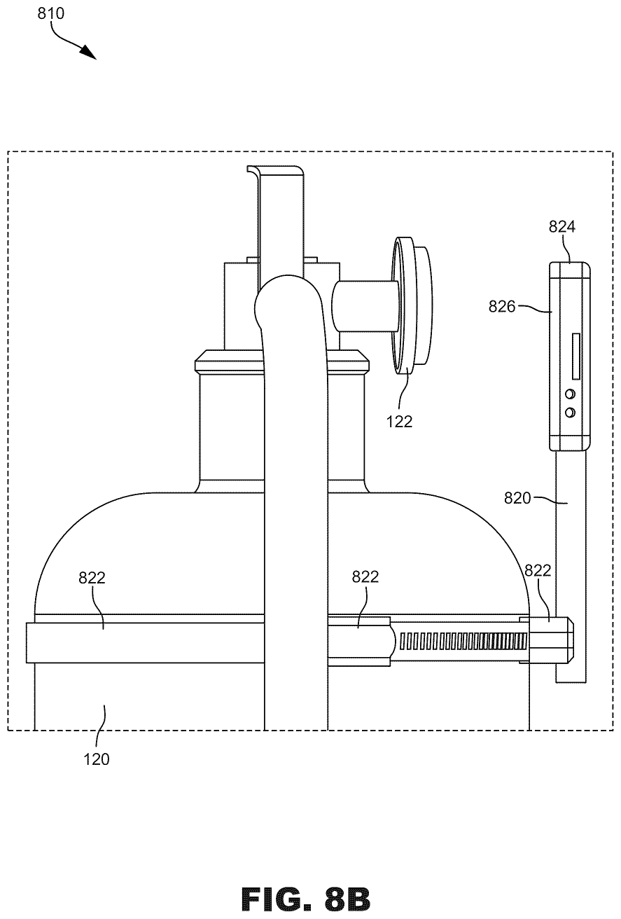

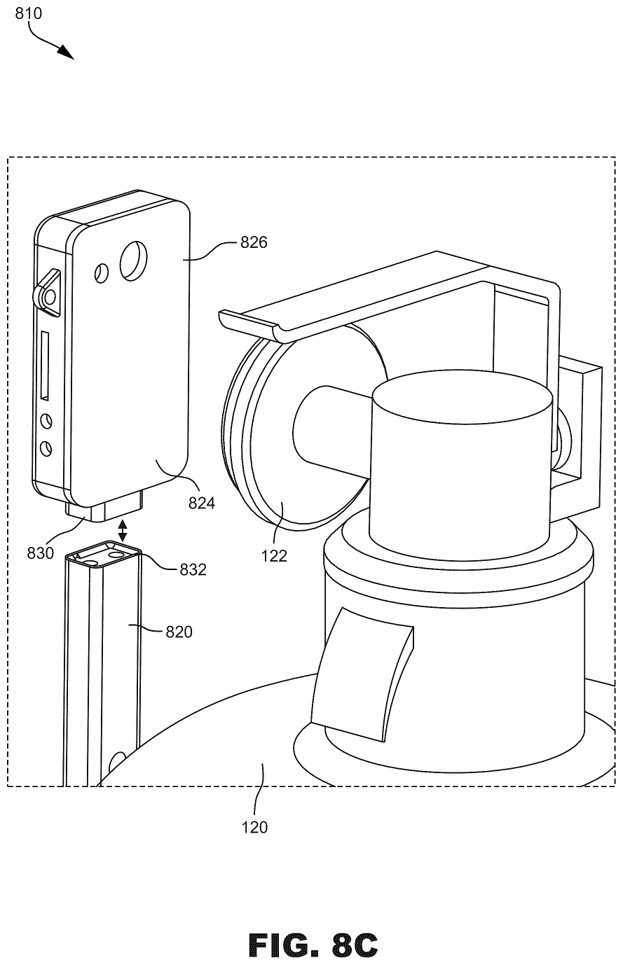

FIG. 8A is a diagram illustrating an example implementation of the smart fire extinguisher installation system 110 that includes a backstop 802 for the fire extinguisher 120, according to some examples of the present disclosure. As shown, the fire extinguisher 120 is mounted on the structure 104 using the smart mount 116. When the fire extinguisher 120 is on the smart mount 116, there is a gap between the fire extinguisher 120 and the structure 104, which can allow the fire extinguisher 120 to move or potentially hit the structure 104.

The ability of the fire extinguisher 120 to move within the gap between the fire extinguisher 120 and the structure 104 can result in damage to the fire extinguisher 120 and/or the structure 104 if the fire extinguisher 120 hits the structure 104 as a result of any movement of the fire extinguisher 120. The movement of the fire extinguisher 120 within the gap between the fire extinguisher 120 and the structure 104 can also result in changes to the position of the pressure gauge 122 of the fire extinguisher 120, which can cause the pressure gauge 122 to move outside of the FOV of the image sensor(s) 220 and thus prevent the image sensor(s) 220 from imaging the pressure gauge 122 or imaging the entire reading surface or display of the pressure gauge 122. As previously explained, the position of the image sensor(s) 220 within the smart fire extinguisher installation system 110 may be carefully calibrated or configured to ensure that the pressure gauge 122 is within the FOV of the image sensor(s) 220 when the fire extinguisher 120 is on the smart mount 116. Therefore, if the fire extinguisher 120 has a certain range of movement, the fire extinguisher 120 can move to a position that places the pressure gauge 122 outside of the FOV of the image sensor(s) 220.

In some examples, a backstop 802 can be placed between the fire extinguisher 120 and the structure 104 to prevent damage to the fire extinguisher 120, damage to the structure 104, and/or misalignment between the FOV of the image sensor(s) 220 and the pressure gauge 122 as a result of movement by the fire extinguisher 120 when the fire extinguisher 120 is on the smart mount 116. The backstop 802 can reduce or prevent the freedom of movement of the fire extinguisher 120 within the gap between the fire extinguisher 120 and the structure 104. In other words, the backstop 802 can reduce or prevent movement (or a certain amount of movement) by the fire extinguisher 120 within the gap between the fire extinguisher 120 and the structure 104 when the fire extinguisher 120 is on the smart mount 116. The backstop 802 can reduce or prevent such movement by the fire extinguisher 120 by reducing or eliminating the gap between the fire extinguisher 120 and the structure 104 when the fire extinguisher 120 is on the smart mount 116. In some cases, the backstop 802 can additionally or alternatively provide friction when the fire extinguisher 120 makes contact with the backstop 802. The friction can help reduce or prevent such movement by the fire extinguisher 120.

The backstop 802 can be made of a material that can absorb energy from an impact between the fire extinguisher 120 and the backstop 802 and/or that can create friction when the fire extinguisher 120 makes contact with the backstop 802 in order to reduce or prevent motion by the fire extinguisher 120. In some examples, the backstop 802 (or a surface of the backstop 802) can include a material that can create friction and/or provide shock absorption or dampening such as, for example and without limitation, rubber, foam, neoprene, silicone, sorbothane, polyurethane, and/or any other friction, shock absorbing, and/or shock dampening material. In some cases, the backstop 802 can additionally or alternatively be filled with a content(s) that can provide shock absorption or dampening such as, for example and without limitation, sand, water, air, foam, and the like.

The size and/or shape of the backstop 802 can vary based on preferences, cost, and/or intended functionality. For example, the size of the backstop 802 can be increase to reduce the gap between the fire extinguisher 120 and the structure 104, or can be reduced to reduce a cost of the backstop 802. As another example, the backstop 802 can be configured to have a U shape, a C shape, a curved shape, a circle or ellipse shape, a square or rectangular shape, a pyramid shape, or any other shape. In some cases, a shape of a side of the backstop 802 facing the fire extinguisher 120 can be contoured to fit or follow a shape of a surface of the fire extinguisher 120 that may come in contact with that side of the backstop 802. The shape of the other side of the backstop 802 facing the structure 104 can additionally or alternatively be contoured to fit or follow a shape of a surface of the structure 104 that may come in contact with the backstop 802.

FIG. 8B is a diagram illustrating an example sensor implementation 810 used to monitor the fire extinguisher 120, according to some examples of the present disclosure. In this example, the sensor implementation 810 can include a sensor apparatus 824 that houses, includes, and/or implements an image sensor (not shown) used to monitor the pressure gauge 122 of the fire extinguisher 120. The sensor apparatus 824 can be coupled to an arm 820, and the arm 820 can be coupled to the fire extinguisher 120 via a coupling component 822.

The arm 820 is configured to hold the sensor apparatus 824 in place and align the image sensor of the sensor apparatus 824 with the pressure gauge 122 such that the pressure gauge 122 is within a FOV of the image sensor of the sensor apparatus 824 when the sensor apparatus 824 is coupled to the arm 820. The image sensor of the sensor apparatus 824 can be configured to face away from a side 826 of the sensor apparatus 824 that faces towards the pressure gauge 122 when the sensor apparatus 824 is coupled to the arm 820. In other words, the image sensor (and/or a pose of the image sensor) of the sensor apparatus 824 can be arranged on the sensor apparatus such that the image sensor faces towards the pressure gauge 122 when the side 826 of the sensor apparatus 824 is coupled to the arm 820 in an arrangement such that the side 826 of the sensor apparatus 824 faces towards the pressure gauge 122, and a FOV of the image sensor of the sensor apparatus 824 extends along a plane (e.g., in space) from the side 826 of the sensor apparatus 824 facing the pressure gauge 122 to the pressure gauge 122. Thus, the sensor apparatus 824 can be coupled to the arm 820 in an arrangement that places or positions the sensor apparatus 824 such that the side 826 of the sensor apparatus 824 faces towards the pressure gauge 122. This way, when the sensor apparatus 824 is coupled to the arm 820 and the arm 820 is coupled to the fire extinguisher 120, the image sensor of the sensor apparatus 824 can capture images of the pressure gauge 122.

In some cases, the sensor apparatus 824 can be detached (e.g., detachable) from the arm 820 as needed/desired. For example, the sensor apparatus 824 can be detachably coupled to the arm 820 via a detachable coupling system such as, for example and without limitation, a magnet or magnetic coupling, a male and female coupling system, a coupler, a screwed joint (or any other joint), a screwed coupling or fitting, a protruding element on the sensor apparatus 824 that can be inserted into a recessed element of the arm 820 (or vice versa), a clamp, a shaft coupling, and/or any other mechanic and/or magnetic coupling system. In such examples, the sensor apparatus 824 can be removed from the arm 820 at any time and for any purpose such as, for example, to replace the sensor apparatus 824 (or the image sensor of the sensor apparatus 824), for maintenance (e.g., for maintenance of the sensor apparatus 824, the image sensor of the sensor apparatus 824, the arm 820, a coupling component 822 used to couple the arm 820 to the fire extinguisher 120, etc.), and/or for any other reason. In other cases, the sensor apparatus 824 can be part of the arm 820 or more permanently coupled or affixed to the arm 820.

The arm 820 can be coupled to the fire extinguisher 120 via a coupling component 822. The coupling component 822 can include any type of coupling component or fixture. For example, the coupling component 822 can include a detachable coupling component that allows the arm 820 and/or the coupling component 822 to be removed/detached from the fire extinguisher 120 such as, for example and without limitation, a bracket, a magnetic coupling, a clamp, a Velcro strip or adhesive, etc. In other cases, the coupling component 822 can be more permanently affixed to the fire extinguisher. For example, the coupling component 822 can be glued, secured, or adhered to the fire extinguisher 120.

The arm 820 can include a mechanical arm, rod, stand, “selfie stick”, prong, shaft, tube, and/or structure configured to align the sensor apparatus 824 with the pressure gauge 122 such that the pressure gauge 122 is within the FOV of the image sensor of the sensor apparatus 824 when the sensor apparatus 824 is coupled to the arm 820 and the arm 820 is coupled to the fire extinguisher 120 via the coupling component 822. In some examples, the length of the arm 820 can be configured to allow extend in a direction toward the pressure gauge 122 relative to the coupling component 822 on the fire extinguisher 120 and/or the coupling point or region where the arm 820 and the coupling component 822 connect (and/or where the coupling component 822 is coupled to the fire extinguisher 120) such that the image sensor of the sensor apparatus 824 is at a height relative to the fire extinguisher 120 and pressure gauge 122 that allows the image sensor of the sensor apparatus 824 to capture images of the pressure gauge 122 (e.g., that places the pressure gauge within the FOV of the image sensor of the sensor apparatus 824).

In some cases, the arm 820 can be extendable to allow the sensor apparatus 824 to be aligned or realigned relative to the pressure gauge 122 as needed when the sensor apparatus 824 is coupled to the arm 820. For example, the arm 820 can include a telescoping arm that allows the length of the arm 820 to be adjusted as needed/desired to adjust an alignment of the image sensor of the sensor apparatus 824 relative to the pressure gauge 122 when the sensor apparatus 824 is coupled to the arm 820 and the arm 820 is coupled to the fire extinguisher 120 via the coupling component 822.

In some cases, the coupling component 822 can be moved and attached to the fire extinguisher 120 along a vertical plane relative to an orientation of the fire extinguisher 120 as needed to place the pressure gauge 122 within the FOV of the image sensor of the sensor apparatus 824, which can depend on the position of the pressure gauge 122 on the fire extinguisher 120, the length of the arm 820, any vertical displacement of the arm 820 relative to the coupling component 822 and/or the fire extinguisher 120 when the arm 820 is coupled to the coupling component 822, the size of the sensor apparatus 824, and/or the position of the image sensor on, within, or relative to the sensor apparatus 824. For example, the coupling component 822 can be coupled to the fire extinguisher 120 at a position, point, or region of the fire extinguisher 120 along or within a vertical plane of the fire extinguisher 120 (e.g., at a height of the fire extinguisher 120) that places the pressure gauge 122 within the FOV of the image sensor of the sensor apparatus 824 when the sensor apparatus 824 is coupled to the arm 820 and the arm 820 is coupled to the fire extinguisher 120 via the coupling component 822, given the position of the coupling component 822 on the fire extinguisher 120 can depend on the position of the pressure gauge 122 on the fire extinguisher 120, the length of the arm 820, any vertical displacement of the arm 820 relative to the coupling component 822 and/or the fire extinguisher 120 when the arm 820 is coupled to the coupling component 822, the size of the sensor apparatus 824, and/or the position of the image sensor on, within, or relative to the sensor apparatus 824.

In some cases, the sensor apparatus 824 can include one or more additional sensors, which can be used to monitor one or more aspects of the fire extinguisher 120 and/or an area relative to the fire extinguisher 120, such as an access area. For example, the sensor apparatus 824 can include one or more sensors facing or pointed towards a side opposite to the side 826 and/or facing or pointed towards a direction along a plane that extends from a side of the sensor apparatus 824 opposite to the side 826 and away from the side 826 of the sensor apparatus 824 (e.g., facing or pointed towards a direction opposite to the side 826 or along a plane extending in a direction away from and opposite to the pressure gauge 122 and the side 826). To illustrate, the sensor apparatus 824 can include one or more sensors facing or pointing in an opposite direction as the image sensor of the sensor apparatus 824 used to capture images of the pressure gauge 122.

The one or more other sensors of the sensor apparatus 824 (e.g., one or more sensors other than the image sensor used to image the pressure gauge 122) can include any sensor(s) described herein. For example, the one or more other sensors can include an ultrasonic sensor distance sensor, a microphone, a position sensor, a RADAR sensor, a LIDAR sensor, another image sensor, a TOF sensor, a GPS receiver, an infrared sensor, an ambient light sensor, a motion sensor, an accelerometer (e.g., in addition to or instead of an IMU), a gyroscope (e.g., in addition to or instead of an IMU), a magnetometer (e.g., in addition to or instead of an IMU), and/or any other sensor. The one or more other sensors can be used to obtain measurements and/or information about one or more conditions, attributes, and/or aspects of an area relative to the fire extinguisher. For example, the one or more other sensors can be used to obtain distance measurements used to determine whether there are any obstructions in an access area of the fire extinguisher 120. The access area can include a predetermined access area and/or can include an access area defined by or determined based on any fire extinguisher regulations or code. As another example, the one or more other sensors can be used to obtain measurements used to determine whether the fire extinguisher 120 has been moved or tampered with, such as location measurements, image data, etc.

FIG. 8C is a diagram illustrating an example view of a coupling of the sensor apparatus 824 of the example sensor implementation 810 used to monitor the fire extinguisher 120, according to some examples of the present disclosure. In this example, the sensor apparatus 824 is detachably coupled to the arm 820 via a magnetic coupling that uses a magnetic field to couple the sensor apparatus 824 to the arm 820. The magnetic coupling can couple (e.g., with or without making direct contact) an end 830 (and/or a surface thereof) of the sensor apparatus 824 to an end 832 (and/or a surface thereof) of the arm 820.

In some examples, the end 830 of the sensor apparatus 824 and the end 832 of the arm 820 can include magnets used to couple (with or without making direct contact) the end 830 (and/or a surface thereof) of the sensor apparatus 824 to the end 832 (and/or a surface thereof) of the arm 820. The magnets on the end 830 of the sensor apparatus 824 and the end 832 of the arm 820 can have opposing poles facing each other, allowing them to magnetically connect and transmit torque through a magnetic force/field. In some cases, the magnets on the end 830 of the sensor apparatus 824 and the end 832 of the arm 820 with the opposing poles facing each other can allow the magnets (and thus the end 830 of the sensor apparatus 824 and the end 832 of the arm 820) to connect and transmit torque without physical contact between the ends 830 and 832.

As shown, the sensor apparatus 824 can be coupled to the arm 820 as previously described, such that the side 826 of the sensor apparatus 824 which faces in or toward a same direction or plane as the image sensor of the sensor apparatus 824, is pointed or facing toward the pressure gauge 122 to allow the image sensor of the sensor apparatus 824 to capture images of the pressure gauge 122. Moreover, the magnetic coupling used to couple the sensor apparatus 824 to the arm 820 can make it easy for a user to remove the sensor apparatus 824 from the arm 820 as needed or desired.

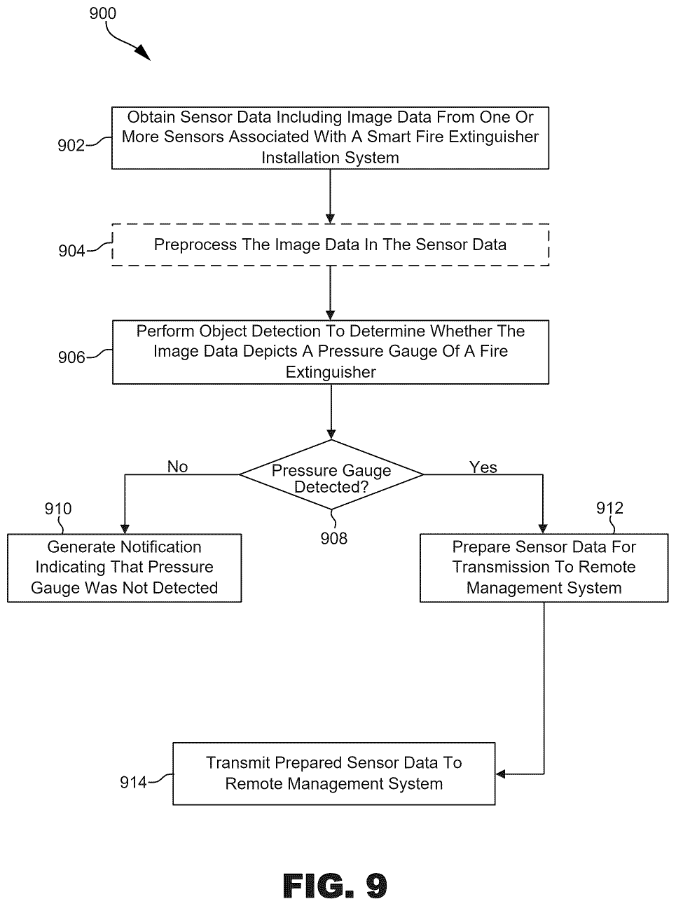

FIG. 9 is a flowchart illustrating an example process 900 for processing fire extinguisher data used to monitor a fire extinguisher 120, according to some examples of the present disclosure. In some examples, the process 900 can be implemented by a smart fire extinguisher installation system 110 including a smart assembly 112, a smart mount 116, sensor systems 126, and/or a sensor implementation 810 as shown in FIGS. 1 through 8C.

At block 902, the processing system 114 on the smart assembly 112 can obtain sensor data including image data from one or more sensors associated with (e.g., implemented by, implemented with, used in conjunction with, included as part of, etc.) the smart fire extinguisher installation system 110. The one or more sensors can include an image sensor(s) 220 used to capture the image data. In some examples, the one or more sensors can additionally include one or more other types of sensors such as an obstruction detection sensor(s) 222, a tamper detection sensor(s) 224, and/or one or more other sensors 226.

For example, in some cases, the one or more sensors can additionally include, for example and without limitation, a TOF sensor, an ultrasonic distance sensor, a RADAR sensor, a LIDAR sensor, a global positioning system (GPS) receiver, a microphone, an ambient light sensor, a pressure sensor, a proximity sensor, a temperature sensor, an infrared sensor, a tilt sensor, a touch sensor, a capacitive sensor, a laser sensor, a humidity sensor, a compass, an impact sensor, an encoder, a photoelectric sensor, a position sensor, a shock detector sensor, an angular rate sensor, an optical position sensor, a photodetector, a load sensor, a strain gauge, a force sensor, a heat sensor, a flame detection sensor, a thermometer or temperature gauge, a motion sensor, a triangulation sensor, a machine vision sensor, an accelerometer and/or a gyroscope (or an IMU), and/or any other sensor.

The one or more sensors can implemented by a smart assembly 112 of the smart fire extinguisher installation system 110; a smart mount 116 of the smart fire extinguisher installation system 110; a cabinet 700 of the smart fire extinguisher installation system 110; a component (e.g., a mechanical arm, a sensor module, a case, etc.) coupled to the smart assembly 112, the smart mount 116 or a prong of the smart mount 116, the cabinet 700, and/or any other component of the smart fire extinguisher installation system 110; and/or any other component of the smart fire extinguisher installation system 110. The components of the smart fire extinguisher installation system 110 can be used to position each sensor of the one or more sensors at a respective position determined based on the type of information that the sensor is intended to measure/capture and/or the type of determinations that the data from such sensor is used for.

For example, if a sensor includes a distance sensor (e.g., an ultrasonic sensor, a TOF sensor, a LIDAR sensor, a RADAR sensor, a proximity sensor, etc.) used to detect whether there are any physical obstructions (and, if so, characteristics of the obstructions such as size, shape, location, etc.) within a particular area surrounding or adjacent to the smart mount 116 (and/or the fire extinguisher 120 when the fire extinguisher 120 is on the smart mount 116), the distance sensor can be positioned by a component of the smart fire extinguisher installation system 110 such that the distance sensor has a view of the area to be monitored for obstructions and/or can obtain distance measurements pertaining to such area, which can be used to monitor the area for obstructions. The area measured by the distance sensor for obstructions can include, for example, a perimeter around or near the smart mount 116 (and/or proximate/adjacent to the smart mount 116) and/or a region within a distance from the smart mount 116 identified as an area that should be free from obstructions (or certain types of obstructions) based on applicable rules or regulations, such as an access area surrounding the smart mount 116. As another example, if the sensor includes an image sensor used to capture images of an area where the pressure gauge 122 is estimated to be when the fire extinguisher 120 is on the smart mount 116 to determine whether the pressure gauge 122 (and thus the fire extinguisher 120) is present and/or to determine a reading of the pressure gauge 122, the image sensor can be positioned by a component of the smart fire extinguisher installation system 110 such that the area to be imaged by the image sensor is within the FOV of the image sensor.

In some examples, the one or more sensors can include a weight sensor (e.g., weight sensor(s) 118) coupled to a prong of the smart mount 116 or multiple weight sensors coupled to multiple prongs of the smart mount 116. In such examples, the sensor data can also include one or more weight measurements obtained by the weight sensor or the multiple weight sensors. The one or more weight measurements can be used to determine whether the fire extinguisher 120 is on the smart mount 116, a weight of the fire extinguisher 120, and/or a fill level of the fire extinguisher 120. In some cases, the weight sensor or the multiple weight sensors can obtain the one or more weight measurements at a time interval, on a schedule, in response to a trigger such as a signal from the processing system 114, automatically when there is a change in weight applied to the smart mount 116, and/or in response to any other trigger. The weight sensor or the multiple weight sensors can provide the one or more weight measurements to the processing system 114 as part of the sensor data obtained by the processing system 114 at block 902.

In some examples, the image data (e.g., an image or video frame) in the sensor data can be captured by and received from an image sensor(s) 220 positioned relative to an area where the pressure gauge 122 is estimated to be when the fire extinguisher 120 is on the smart mount 116. For example, the image sensor(s) 220 can be positioned relative to the area where the pressure gauge 122 is estimated to be when the fire extinguisher 120 is on the smart mount 116 such that the area where the pressure gauge 122 is estimated to be when the fire extinguisher 120 is on the smart mount 116 is within the FOV of the image sensor(s) 220 when the image sensor(s) 220 captured the image data. This way, the image data should depict the pressure gauge 122 of the fire extinguisher 120 if the fire extinguisher 120 is on the smart mount 116. If the image data does not depict the pressure gauge 122, the fact that the pressure gauge 122 is not depicted in the image data can indicate that the fire extinguisher 120 is not on the smart mount 116.

In some examples, to position the image sensor(s) 220 relative to the area where the pressure gauge 122 is estimated to be when the fire extinguisher 120 is on the smart mount 116, the image sensor(s) 220 can be installed on or coupled to a case 314 coupled to the smart assembly 112 and positioned relative to the area where the pressure gauge 122 is estimated to be such that the area would be within the FOV of the image sensor(s) 220 on the case 314. In some cases, the case 314 can be coupled to a canopy 402 that protrudes forward relative to a structure 104 on which the smart assembly 112 and the smart mount 116 are coupled to (e.g., mounted on, attached to, etc.) and above the area where the pressure gauge 122 is estimated to be when the fire extinguisher 120 is on the smart mount 116, as shown in FIGS. 4A-B. In other cases, the case 314 can be coupled to or part of a mechanical arm 312 that can be manually or mechanically moved (e.g., via a motor or actuator) to an extended position 318 to place the image sensor(s) 220 relative to the area where the pressure gauge 122 is estimated to be when the fire extinguisher 120 is on the smart mount 116 such that the area where the pressure gauge 122 is estimated to be is within the FOV of the image sensor(s) 220 when the image sensor(s) 220 captures the image data. This way, the image data can depict the area where the pressure gauge 122 is estimated to be and should depict the pressure gauge 122 if the fire extinguisher 120 is on the smart mount 116.

In some examples, the case 314 can be part of an end of the mechanical arm 312 or coupled to an end of the mechanical arm 312. When the mechanical arm 312 is in the extended position 318, the case 314 and the image sensor(s) 220 are positioned above the area where the pressure gauge 122 is estimated to be such that the area is within the FOV of the image sensor(s) 220. For example, in the extended position 318, the mechanical arm 312 can protrude forward relative to a structure 104 on which the smart assembly 112 and the smart mount 116 are coupled to and above the area where the pressure gauge 122 is estimated to be when the fire extinguisher 120 is on the smart mount 116, as shown in FIGS. 3A-B. In some cases, the mechanical arm 312 can be manually moved by a user to the extended position 318 from a different position 316. The mechanical arm 312 can include a hinge that allows the mechanical arm 312 to be moved to the extended position 318 before the image sensor(s) 220 captures the image data, or a rotating and/or extending mechanism that allows the mechanical arm 312 to be moved to the extended position 318 before the image sensor(s) 220 captures the image data. In some cases, the mechanical arm 312 can include a telescoping configuration that allows the mechanical arm 312 to be extended to the extended position 318 before the image sensor(s) 220 captures the image data. In other cases, the mechanical arm 312 can be coupled to a motor or actuator on the smart assembly 112 configured to move the mechanical arm 312 to the extended position 318 before the image sensor(s) 220 captures the image data.

In other cases, the image sensor(s) 220 can be included in a sensor module 506 implemented by a prong 502 of the smart mount 116. Here, the sensor module 506 can include a portion 508 that can automatically or manually move to an engaged position 512 when the fire extinguisher 120 is placed on the smart mount 116. For example, the image sensor(s) 220 can be placed on or housed by a portion 508 of the sensor module 506 that snaps into the engaged position 512 when the fire extinguisher 120 is placed on the smart mount 116, as shown in FIGS. 5A-B. When the portion 508 of the sensor module 506 is in the engaged position 512, the image sensor(s) 220 on the portion 508 of the sensor module 506 can face towards, and extend forward relative to, the smart assembly 112, the structure 104 on when the smart mount 116 is mounted on, and the pressure gauge 122 (if the fire extinguisher 120 is on the smart mount 116). This way, the image data captured by the image sensor(s) 220 may depict the pressure gauge 122 if the fire extinguisher 120 is on the smart mount 116.

In other examples, the image sensor(s) 220 can be implemented by or housed in a sensor module 606 coupled to an end of a prong 602 of the smart mount 116, as shown in FIGS. 6A-B. The sensor module 606 can manually or automatically snap into a closed position 610 that places the image sensor(s) 220 in a position such that the image sensor(s) 220 faces toward the area where the pressure gauge 122 is estimated to be when the fire extinguisher 120 is on the smart mount 116, and places that area within the FOV of the image sensor(s) 220, as shown in FIG. 6B.

In yet other examples, the image sensor(s) 220 can be implemented on a door 704 of a cabinet 700 used to mount the fire extinguisher 120. The cabinet 700 can include a box 702 where the fire extinguisher 120 can be housed, and a smart mount 116 where the fire extinguisher 120 can be placed on to mount the fire extinguisher 120. The image sensor(s) 220 can be positioned within an interior of the door 704 such that the image sensor(s) 220 faces towards the smart mount 116 and the area where the pressure gauge 122 is estimated to be when the fire extinguisher 120 is on the cabinet 700, as shown in FIG. 7A.

At block 904, the processing system 114 can optionally preprocess the image data in the sensor data. In some examples, the processing system 114 can preprocess the image data in the sensor data to prepare the image data for processing as described herein. For example, the processing system 114 can enhance an image contrast of the image data using an image enhancement algorithm (e.g., Contrast Limited Adaptive Histogram Equalization, etc.), perform white balance and color correction, modify the image brightness to achieve a target mean value so the image data has the same average brightness, perform noise reduction while preserving image edges, perform gamma correction, etc.

In some cases, the pressure gauge 122 can include a pressure reading display that depicts a needle used to read the pressure on the pressure gauge 122. In some cases, the pressure reading display can depict the needle in yellow and one or more regions of green color representing a range(s) of pressure levels. Here, the processing system 114 can optionally perform yellow and green enhancement on the image data to help a system identify the needle and read/classify (e.g., using machine vision, classification, etc.) the pressure levels of the pressure gauge 122 as depicted in the image data. For example, the processing system 114 can increase the sensitivity to green and yellow blobs of image data to help a software model(s) locate the needle and detect or classify the pressure ranges of the pressure gauge 122 depicted in the image data, including the pressure ranges that are deemed compliant with relevant rules or regulations. In some cases, the processing system 114 can calculate the needle angle as depicted in the image data to determine the pressure levels of the fire extinguisher 120. In some examples, the processing system 114 can calculate the centroids of the yellow needle and the left and right boundaries of the green zone depicted in the image data. The processing system 114 can use the values corresponding to the centroids of the yellow needle and the left and right boundaries of the green zone to determine the angle of the needle relative to the green zone.

At block 906, the processing system 114 can perform object detection to determine whether the image data depicts the pressure gauge 122 of the fire extinguisher 120. For example, the processing system 116 can use the software model(s) 210 to perform object detection on the image data to detect the pressure gauge 122 in the image data if the pressure gauge 122 is depicted in the image data. In some cases, the software model(s) 210 can include a neural network, such as a convolutional neural network, configured to process image data and detect pressure gauges in the image data. In some aspects, if the processing system 114 detects the pressure gauge 122 in the image data, the processing system 114 can crop the image data to include a portion depicting the pressure gauge 122, such as a bounding box corresponding to one or more blocks of image data depicting the pressure gauge 122.

At block 908, the processing system 114 determines whether the pressure gauge 122 was detected in the image data by the object detection. If the processing system 114 does not detect the pressure gauge 122 in the image data, the process system 114 can proceed to block 910. At block 910, the processing system 114 can generate a notification indicating that the pressure gauge 122 was not detected. The notification can alert a user and/or system that the pressure gauge 122 was not detected in the image data, which can indicate that the fire extinguisher 120 is not on the smart mount 116 (e.g., the fire extinguisher 120 was removed from the smart mount 116 and has not been returned to the smart mount 116). In some cases, the processing system 114 can transmit the notification to another device, such as a client device, for presentation to a user.

In some cases, the processing system 114 can additionally or alternatively transmit and/or store the notification in a remote system, such as the remote management system 150, a database of monitoring events/records on the remote management system 150 (or any other system), etc. In some examples, the processing system 114 can additionally or alternatively transmit the notification to one or more users or user devices. For example, the processing system 114 can send an email with the notification to one or more users and/or send the notification via a text message to one or more devices associated with one or more users.

The notification can alert a user(s) and/or device(s) about the failure to detect the pressure gauge 120, which can be used to determine whether the detection results should be verified (e.g., by user inspection and/or by capturing additional image data to check for the pressure gauge 122) and/or whether any corrective actions should be implemented, such as searching for the fire extinguisher 120, verifying whether the fire extinguisher 120 is on the smart mount 116, placing the fire extinguisher 120 back in the smart mount 116, placing a different or new fire extinguisher in the smart mount 116, notifying a particular user, etc.

If, on the other hand, the processing system 114 detects the pressure gauge 122 in the image data, the process system 114 can proceed to block 912. At block 912, the processing system 114 can prepare the sensor data for transmission to the remote management system 150. The processing system 114 can transmit the sensor data to the remote management system 150 so the remote management system 150 can perform additional monitoring tasks using the sensor data, such as determining a pressure level of the fire extinguisher 120 as shown in the image data depicting the pressure gauge 122, determining a weight of the fire extinguisher 120 (e.g., based on one or more weight measurements by the weight sensor(s) 118), determine any obstruction and/or tampering conditions associated with the fire extinguisher 120, determining environmental conditions in the area associated with the fire extinguisher 120 (e.g., temperature, ambient light levels, humidity, etc.), and/or any other tasks as described herein.

In some cases, preparing the sensor data for transmission to the remote management system 150 can include compressing and/or deconstructing the image data from the sensor data. For example, the processing system 114 can deconstruct one or more images associated with the image data for more efficient transmission and/or storage. In some examples, the image deconstruction can including bitstream conversion (e.g., converting a quantized image from the image data into a bitstream representation, which can be generated using one or more traversal methods such as diagonal, vertical, or spiral), perform run-length encoding to further compress the bitstream, uplink and byte packing to convert the bitstream into a series of n-byte packets where n represents a positive number, and/or any other image deconstruction techniques.

In some cases, the processing system 114 can perform image compression to compress the image data in the sensor data. For example, the processing system 114 can perform quantization by mapping the colors in the image data to a predefined set of colors to reduce the overall color space, downscaling to reduce the image dimensions to a specific size, lossy compression based on a particular image format such as Joint Photographic Experts Group (JPEG) compression to compress the image data using the JPEG format to reduce the file size of the image data, and/or any other compression technique.

In some cases, if the sensor data includes other types of sensor data in addition to the image data, the processing system 114 can optionally compress the other sensor data using any other compression technique.

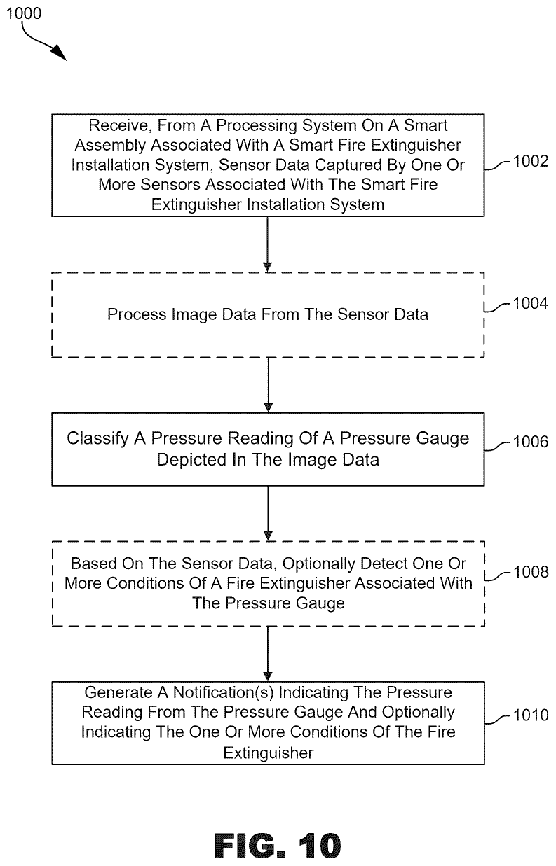

At block 914, the processing system 114 can transmit the prepared sensor data to the remote management system 150. The processing system 114 can transmit the prepared sensor data to the remote management system 150 for further processing as further described herein. For example, the remote management system 150 can process the prepared sensor data as described below with respect to the process 1000 shown in FIG. 10.

In some cases, instead of preparing the sensor data at block 912 and transmitting the prepared sensor data at block 914, the processing system 114 can further process the sensor data locally, rather than (or in addition to) using the remote management system 150 to further process the sensor data. For example, in some cases, the processing system 114 can process the sensor data according to the process 1000 shown in FIG. 10, and further described below.

FIG. 10 is a flowchart illustrating an example process 1000 for monitoring a fire extinguisher based on data (e.g., sensor data) collected from one or more sensors associated a smart fire extinguisher installation system used to mount the fire extinguisher, according to some examples of the present disclosure. The process 1000 will be described with respect to the remote management system 150 performing the process 1000. However, in other examples, the process 1000 (or one or more steps of the process 1000) can be performed locally by the processing system 114 based on the sensor data received by the processing system 114 from one or more sensors, such as the sensor data described above with respect to FIG. 9.

At block 1002, the remote management system 150 can receive, from the processing system 114, sensor data captured by one or more sensors (e.g., one or more sensors from the weight sensor(s) 118 and the sensor systems 124) associated with the smart fire extinguisher installation system 110. In some cases, the sensor data can include image data captured by the image sensor(s) 220. The image data can depict an area where the pressure gauge 122 of the fire extinguisher 120 is estimated to be when the fire extinguisher 120 is on the smart mount 116 associated with the smart assembly 112 that includes the processing system 114. Thus, if the fire extinguisher 120 is mounted on the smart mount 116, the image data can depict the pressure gauge 122 of the fire extinguisher 120 while the fire extinguisher 120 is on the smart mount 116. The image data can be used to determine whether the fire extinguisher 122 is on the smart mount 116 and/or the determine a pressure level of the fire extinguisher 120 by classifying a pressure reading level of the pressure gauge 122 depicted in the image data.

In some cases, instead of including the image data, the sensor data can include data identifying an angle of a needle of the pressure gauge 122 as depicted in the image data. The angle of the needle can be used to estimate the pressure level of the fire extinguisher 120. In some cases, the processing system 114 can extract the information identifying the angle of the needle of the pressure gauge 122 from the image data when processing the image data (e.g., as part of the example process 900 shown in FIG. 9).

In some cases, the sensor data can include data from other sensors such as, for example, a weight measurement(s) from the weight sensor(s) 118, one or more measurements (e.g., distance measurements, motion measurements, position measurements, shape measurements, etc.) from the obstruction detection sensor(s) 222, one or more measurements (e.g., accelerometer measurements, gyroscope measurements, motion measurements, impact or shock measurements, etc.) from the tamper detection sensor(s) 224, and/or other measurements from one or more other sensors 226.

At block 1004, the remote management system 150 can optionally process image data from the sensor data. For example, if the sensor data includes image data depicting the pressure gauge 122 or depicting an area where the pressure gauge 122 is estimated to be when the fire extinguisher 120 is on the smart mount 116, the remote management system 150 can optionally process the image data to reconstruct any images from the image data, enhance the image data, upscale the image data, etc.

At block 1006, the remote management system 150 can classify a pressure reading of the pressure gauge 122 depicted in the image data. The remote management system 150 can determine the pressure levels of the fire extinguisher 120 based on the classification of the pressure reading of the pressure gauge 122 as depicted in the image data. In some examples, the remote management system 150 can use the software model(s) 152 to classify the pressure reading of the pressure gauge 122 depicted in the image data. The software model(s) 152 can include an AI/ML model trained to perform classification to classify pressure readings of pressure gauges depicted in image data.

In some cases, the pressure gauge 122 can include a pressure reading display that depicts a needle used to read the pressure on the pressure gauge 122. The pressure reading display can depict the needle in a particular color, such as yellow, and use a different color, such as green, to depict one or more regions representing a range(s) of pressure levels, such as a range of pressure levels that are within an upper threshold (or maximum) and a lower threshold (or a minimum). Here, the software model(s) 152 of the remote management system 150 can identify the needle depicted in the particular color, such as yellow, and the range(s) of pressure levels depicted in the different color, such as green. The software model(s) 152 can use the detection of the needle and the range(s) of pressure levels depicted in the different color (e.g., green) to read/classify (e.g., using machine vision, classification, etc.) the pressure levels of the pressure gauge 122 as depicted in the image data.

In some cases, the software model(s) 152 can calculate the needle angle as depicted in the image data to classify the pressure readings and/or determine the pressure levels of the fire extinguisher 120. In some examples, the software model(s) 152 can calculate the centroids of the needle (and/or the color used to depict the needle) and the left and right boundaries of the color zone (e.g., the green zone) depicted in the image data and corresponding to the range(s) of pressure levels. The software model(s) 152 can use the values corresponding to the centroids of the needle and the left and right boundaries of the color zone to determine the angle of the needle relative to the color zone, and thereby determine the pressure levels of the fire extinguisher 120.

At block 1008, the remote management system 150 can optionally detect one or more conditions of the fire extinguisher 120 associated with the pressure gauge 122 based on the sensor data. For example, the software model(s) 152 can use any weight measurements in the sensor data to determine a weight and/or fill level of the fire extinguisher 120. The software model(s) 152 can additionally or alternatively use distance measurements in the sensor data to determine whether there are any physical obstructions (or certain types of obstructions or obstructions with certain characteristics such as shape, size, etc.) in an area relative to the smart mount 116, such as a perimeter or range relative to the smart mount 116 and the fire extinguisher 120 on the smart mount 116 (if the fire extinguisher 120 is on the smart mount 116).

In some cases, the software model(s) 152 can additionally or alternatively use other measurements in the sensor data to detect any tampering with the fire extinguisher 120. For example, the software model(s) 152 can detect any tampering with the fire extinguisher 120 based on accelerometer and/or gyroscope data, which can indicate whether the fire extinguisher 120 was moved; shock or impact measurements, which can indicate whether the fire extinguisher 120 was impacted and potentially damaged; motion sensor measurements, which can indicate whether the fire extinguisher 120 was moved; position sensor measurements, which can indicate how and/or where the fire extinguisher 120 is positioned/placed; etc.

In some examples, the remote management system 150 can use the sensor data to make fire extinguisher compliance determinations based on relevant rules or regulations. In some cases, the fire extinguisher compliance determinations can be based on the one or more conditions of the fire extinguisher 120 determined at block 1008. For example, the remote management system 150 can use the sensor data to determine one or more conditions such as whether access to the fire extinguisher 120 is obstructed, whether the fire extinguisher 120 has been tampered with, whether a weight of the fire extinguisher 120 is within an expected or allowed range, whether the pressure gauge 122 shows proper pressurization of the fire extinguisher 120, whether a door 704 of a cabinet 700 is open (if the fire extinguisher 120 is mounted using a cabinet 700), whether the fire extinguisher 120 is missing from the smart mount 116 or has been moved, etc.

At block 1010, the remote management system 150 can generate a notification indicating the pressure reading from the pressure gauge 122 and optionally indicating the one or more conditions of the fire extinguisher 120. The pressure reading can include a pressure level determined based on the image data depicting the pressure gauge 122, as previously described.

The one or more conditions of the fire extinguisher 120 can include, for example and without limitation, whether access to the fire extinguisher 120 is obstructed, whether the fire extinguisher 120 has been tampered with, whether a weight of the fire extinguisher 120 is within an expected or allowed range, whether the pressure gauge 122 shows proper pressurization of the fire extinguisher 120, whether a door 704 of a cabinet 700 is open (if the fire extinguisher 120 is mounted using a cabinet 700), whether the fire extinguisher 120 is missing from the smart mount 116 or has been moved, etc.

The notification can alert a user(s) and/or system(s) about the pressure reading from the pressure gauge 122 and/or about the one or more conditions of the fire extinguisher 120. In some cases, the remote management system 150 can transmit the notification to another device, such as a client device, for presentation to a user. In some cases, the remote management system 150 can additionally or alternatively transmit and/or store the notification in another system, a database of monitoring events/records, etc. In some examples, the remote management system 150 can additionally or alternatively transmit the notification to one or more users or user devices. For example, the remote management system 150 can send an email with the notification to one or more users and/or send the notification via a text message to one or more devices associated with one or more users.

The notification can alert a user(s) and/or device(s) about the pressure reading and/or the one or more conditions associated with the fire extinguisher 120. In some cases, the notification can indicate a compliance of the fire extinguisher 120 with applicable rules or regulations and/or one or more corrective actions proposed for addressing any compliance issues. In other cases, the information in the notification can be used to determine such compliance of the fire extinguisher 120 and/or such corrective actions. In some cases, the information from the notification (and/or any other related information) can be added to a store or database of monitoring records/data accessible from a tag associated with the fire extinguisher 120, such as the tag 302 shown in FIGS. 3A through 6B.

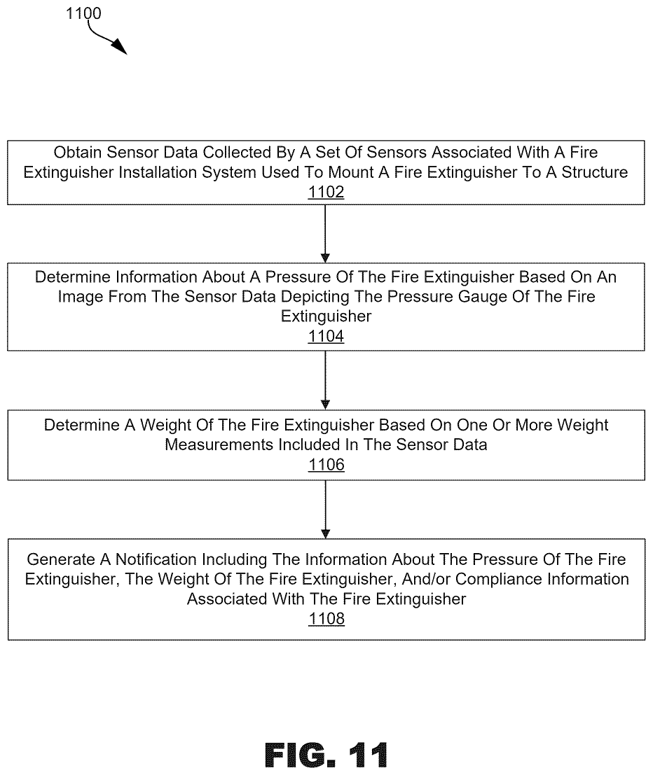

FIG. 11 is a flowchart illustrating an example process 1100 for installing and monitoring a fire extinguisher, according to some examples of the present disclosure. At block 1102, the process 1100 can include obtaining sensor data collected by a set of sensors (e.g., weight sensor(s) 118, sensor systems 124) associated with (e.g., implemented by, implemented with, used by or in conjunction with, included as part of, communicatively coupled to, etc.) a fire extinguisher installation system 110 used to mount a fire extinguisher 120 to a structure 104. In some examples, the sensor data can include an image depicting a pressure gauge 122 of the fire extinguisher 120.

In some cases the sensor data can additionally include one or more weight measurements generated by a weight sensor(s) 118 installed on one or more prongs of a mount 116 used to mount the fire extinguisher 120 to the structure 104. In some cases, a prong of the mount can include multiple weight sensors. For example, a prong of the mount can include a weight sensor on a first side (e.g., a top side) of the prong and another weight sensor on a second side (e.g., a bottom side) of the prong.

In some cases, the sensor data can additionally include other type of sensor data such as, for example and without limitation, distance/depth measurements from one or more distance/range sensors (e.g., TOF sensor, ultrasonic sensor, RADAR sensor, LIDAR sensor, etc.), accelerometer data, gyroscope data, position and/or location data from one or more position and/or location sensors, etc.

At block 1104, the process 1100 can include determining information about a pressure of the fire extinguisher 120 based on the image depicting the pressure gauge 122 of the fire extinguisher 120. In some cases, the information about the pressure of the fire extinguisher 120 can include a pressure reading or classification generated based on the image or information about a position or angle of a needle of the pressure gauge 122 of the fire extinguisher 120. For example, in some cases, the process 1100 can use an AI model (e.g., software model(s) 210, software model(s) 152) to classify the pressure reading depicted in the image of the pressure gauge 122 to determine the pressure of the fire extinguisher 120. In some cases, the process 1100 (e.g., the AI model or any other system described herein) can determine the pressure by detecting a needle of the pressure gauge 122 and determining an angle of the needle. The angle in the needle can be used to determine the pressure of the fire extinguisher 120 as shown in the image of the pressure gauge 122.

At block 1106, the process 1100 can include determining a weight of the fire extinguisher 120 based on one or more weight measurements in the sensor data. The one or more weight measurements can be generated by a weight sensor installed on a mount 116 used to mount the fire extinguisher 120 to the structure 104.

At block 1108, the process 1100 can include generating a notification including the information about the pressure of the fire extinguisher 120, the weight of the fire extinguisher 120, and/or compliance information associated with the fire extinguisher 120. In some cases, the compliance information can be based on and/or relate to the information about the pressure of the fire extinguisher 120 and/or the weight of the fire extinguisher 120. In some examples, the compliance information can include a weight compliance determined based on the weight of the fire extinguisher 120 and fire extinguisher compliance regulations, a pressure compliance determined based on the pressure of the fire extinguisher 120 and the fire extinguisher compliance regulations, an access compliance determined based on the fire extinguisher compliance regulations and one or more physical obstructions detected within a threshold range or perimeter from the fire extinguisher 120 based on the sensor data, a condition (e.g., a tampering condition/event) of the fire extinguisher 120 detected based on the sensor data and determined to qualify as a non-compliant tampered state based on the fire extinguisher compliance regulations, and/or any other fire extinguisher compliance information.

In some examples, the set of sensors can include the weight sensor and an image sensor, and the image can be captured by the image sensor from a position and orientation that aligns a FOV of the image sensor with a region in space where the pressure gauge 122 is predicted to be when the fire extinguisher 120 is mounted to the structure 104 using the mount 116.

In some aspects, the image sensor can be coupled to a top portion of an assembly 112 associated with the mount 116 and held by the top portion of the assembly 112 in the position and orientation that aligns the FOV of the image sensor with the region in space where the pressure gauge 122 is predicted to be when the fire extinguisher 120 is mounted. In some examples, the top portion of the assembly can be shaped as a canopy that protrudes away from a bottom portion of the assembly and is suspended over the mount 116 and the region in space where the pressure gauge 122 is predicted to be when the mount 116 and the assembly 112 are mounted to the structure 104.

In some aspects, the set of sensors can include an image sensor used to capture the image and implemented by or coupled to a mechanical arm 312 that is coupled to the assembly 112. The assembly 112 can house a processing system 114 that is communicatively coupled to the one or more sensors, and the mechanical arm 312 can be moveable from a first pose to a second pose configured to place the image sensor in the position and orientation that aligns the FOV of the image sensor with the region in space where the pressure gauge is predicted to be when the fire extinguisher 120 is mounted to the structure 104 using the mount 116. In some cases, the mechanical arm 312 can be moveable via a hinge, a motor (e.g., a servo motor or any other motor) configured to move the mechanical arm 312 between the first pose and the second pose, and/or an actuator configured to move the mechanical arm 312 between the first pose and the second pose.

In some examples, the mechanical arm 312 can include or be coupled to one or more additional sensors from the set of sensors, such as an ultrasonic sensor, an accelerometer, a gyroscope, a RADAR sensor, a LIDAR sensor, a TOF sensor, an ambient light sensor, a motion sensor, a proximity sensor, a shock detection sensor, an infrared sensor, a laser sensor, a GPS receiver, a humidity sensor, a microphone, a pressure sensor, a tilt sensor, a touch sensor, a capacitive sensor, a compass, an impact sensor, an encoder, a photoelectric sensor, a position sensor, an angular rate sensor, an optical position sensor, a photodetector, a load sensor, a strain gauge, a force sensor, a heat sensor, a flame detection sensor, a thermometer or temperature gauge, a triangulation sensor, a machine vision sensor, an IMU, and/or any other sensor.

In some aspects, the mount 116 can include at least one prong (e.g., one prong or multiple prongs) configured to hold the fire extinguisher 120 in place when the fire extinguisher 120 is placed on the mount 116. The at least one prong can be coupled to a sensor assembly that includes an image sensor used to capture the image. In some examples, a first portion of the sensor assembly can be moveable relative to a second portion of the sensor assembly. For example, the first portion of the sensor assembly can be moveable from a first pose to a second pose. In some examples, the second pose can be positioned further away from a first prong and towards a second prong of the mount 116 than the first pose. In some cases, the second pose of the first portion of the sensor assembly can be configured to place the image sensor in the position and orientation that aligns the FOV of the image sensor with the region in space where the pressure gauge 122 is predicted to be when the fire extinguisher 120 is mounted to the structure 104 using the mount 116. In some cases, the first portion of the sensor assembly can include a paddle that houses the image sensor, and the paddle can include a spring configured to automatically move to the paddle from the first pose to the second pose when the fire extinguisher is placed on the mount.

In some aspects, the image sensor can be included, housed, or implemented by a sensor apparatus (e.g., sensor apparatus 824) coupled to an arm (e.g., arm 820) that is coupled to the fire extinguisher 120 (e.g., via a coupling component such as coupling component 822). For example, the image sensor can be included in a sensor apparatus that can be magnetically coupled to an arm that is coupled to the fire extinguisher 120 and used to hold the sensor apparatus in place and align the image sensor of the sensor apparatus relative to the pressure gauge 122 such that the pressure gauge 122 is within the FOV of the image sensor.

In some cases, the fire extinguisher installation system 110 can include a cabinet 700 configured to house the fire extinguisher 120. The cabinet 700 can include the mount 116 and an assembly 112 that houses a processing system 114 communicatively coupled to the set of sensors. The image sensor used to capture the image can be coupled to a side of a door 704 of the cabinet 700. In some examples, the image sensor can be coupled to the side of the door 704 in the position and orientation that aligns the FOV of the image sensor with the region in space where the pressure gauge 122 is predicted to be when the fire extinguisher 120 is mounted to the structure 104 using the mount 116 and the cabinet 700.

In some aspects, the set of sensors can include an image sensor used to capture the image, and the process 1100 can include obtaining an additional image captured by the image sensor from a position and orientation that aligns a FOV of the image sensor with a region in space where the pressure gauge 122 is predicted to be when the fire extinguisher 120 is mounted to the structure 104 using the mount 116, determining whether the additional image depicts the pressure gauge, and in response to a failure to detect the pressure gauge in the additional image, generating an alert. The alert can include an indication of the failure to detect the pressure gauge 122 and/or an indication that the fire extinguisher 120 is not on the mount 116 or was moved from the mount 116. In some cases, the process 1100 can use an AI model to determine whether the additional image depicts the pressure gauge.

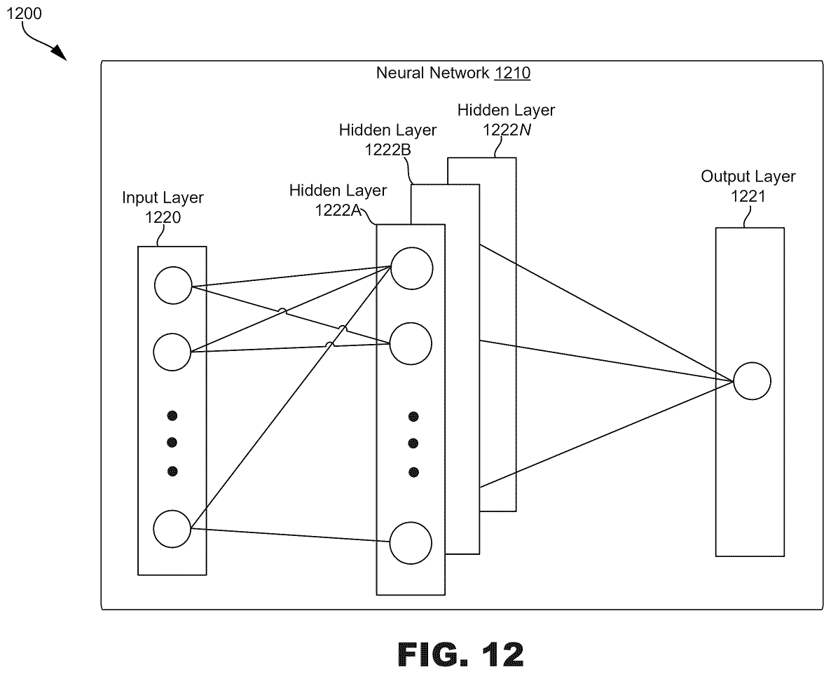

FIG. 12 is a diagram illustrating an example architecture 1200 of an example neural network 1210. The example architecture 1200 can be used to implement any neural network described herein and/or any components described herein that can include or implement a neural network. For example, the architecture 1200 can be used to implement a neural network implemented by the software model(s) 152 and/or the software model(s) 210.

The architecture 1200 of the neural network 1210 can include an input layer 1220 that can be configured to receive and process data to generate one or more outputs. The architecture 1200 of the neural network 1210 can also include hidden layers 1222a, 1222b, through 1222n. The hidden layers 1222a, 1222b, through 1222n include “n” number of hidden layers, where “n” is an integer greater than or equal to one. The number of hidden layers can be made to include as many layers as needed for the given application. The architecture 1200 of the neural network 1210 can further include an output layer 1221 that provides an output resulting from the processing performed by the hidden layers 1222a, 1222b, through 1222n.

The neural network 1210 is a multi-layer neural network of interconnected nodes. Each node can represent a piece of information. Information associated with the nodes is shared among the different layers and each layer retains information as information is processed. In some cases, the neural network 1210 can include a feed-forward network, in which case there are no feedback connections where outputs of the network are fed back into itself. In some cases, the neural network 1210 can include a recurrent neural network, which can have loops that allow information to be carried across nodes while reading in input.

Information can be exchanged between nodes through node-to-node interconnections between the various layers. Nodes of the input layer 1220 can activate a set of nodes in the first hidden layer 1222a. For example, as shown, each of the input nodes of the input layer 1220 is connected to each of the nodes of the first hidden layer 1222a. The nodes of the first hidden layer 1222a can transform the information of each input node by applying activation functions to the input node information. The information derived from the transformation can then be passed to and can activate the nodes of the next hidden layer 1222b, which can perform their own designated functions. Example functions include convolutional, up-sampling, data transformation, and/or any other suitable functions. The output of the hidden layer 1222b can then activate nodes of the next hidden layer, and so on. The output of the last hidden layer 1222n can activate one or more nodes of the output layer 1221, at which an output is provided. In some cases, while nodes in the neural network 1210 are shown as having multiple output lines, a node can have a single output and all lines shown as being output from a node represent the same output value.

In some cases, each node or interconnection between nodes can have a weight that is a set of parameters derived from the training of the neural network 1210. Once the neural network 1210 is trained, it can be referred to as a trained neural network, which can be used to generate one or more outputs. For example, an interconnection between nodes can represent a piece of information learned about the interconnected nodes. The interconnection can have a tunable numeric weight that can be tuned (e.g., based on a training dataset), allowing the neural network 1210 to be adaptive to inputs and able to learn as more and more data is processed.

The neural network 1210 is pre-trained to process the features from the data in the input layer 1220 using the different hidden layers 1222a, 1222b, through 1222n in order to provide the output through the output layer 1221.

In some cases, the neural network 1210 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 1210 is trained well enough so that the weights of the layers are accurately tuned.

To perform training, a loss function can be used to analyze an error in the output. Any suitable loss function definition can be used, such as a Cross-Entropy loss. Another example of a loss function includes the mean squared error (MSE), defined as E_total=Σ(½(target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 1210 can perform a backward pass by determining which inputs (weights) most contributed to the loss of the network and can adjust the weights so that the loss decreases and is eventually minimized.

The neural network 1210 can include any suitable deep network. One example neural network is a Convolutional Neural Network (CNN), which includes an input layer and an output layer with multiple hidden layers between the input and out layers. The hidden layers of a CNN include a series of convolutional, nonlinear, pooling (for downsampling), and fully connected layers. Another example neural network includes a transformer network, which can be used to implement a large language model for example. The neural network 1210 can include any other deep network other than a transformer or CNN, such as an encoder-decoder network, an encoder-only network, a decoder-only network, a mixture of experts (MoE) network, a generative model network, an autoencoder, a Deep Belief Net (DBN), a Recurrent Neural Network (RNN), among others.

As understood by those of skill in the art, machine-learning based techniques can vary depending on the desired implementation. For example, machine-learning schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

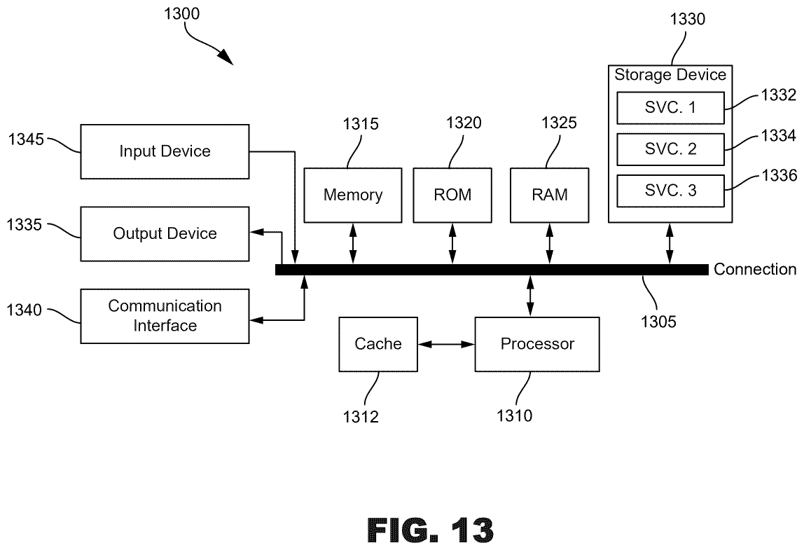

FIG. 13 illustrates an example processor-based system with which some aspects of the subject technology can be implemented. For example, processor-based system 1300 can be any computing device making up processing system 114, any of the client devices 140, the remote management system 150, or any component thereof in which the components of the system are in communication with each other using connection 1305. Connection 1305 can be a physical connection via a bus, or a direct connection into processor 1310, such as in a chipset architecture. Connection 1305 can also be a virtual connection, networked connection, or logical connection.

In some examples, computing system 1300 is a distributed system in which the functions described in this disclosure can be distributed within a datacenter, multiple data centers, a peer network, etc. In some cases, one or more of the described system components represents many such components each performing some or all of the function for which the component is described. In some embodiments, the components can be physical or virtual devices.

Example system 1300 includes at least one processing unit (CPU or processor) 1310 and connection 1305 that couples various system components including system memory 1315, such as read-only memory (ROM) 1320 and random-access memory (RAM) 1325 to processor 1310. Computing system 1300 can include a cache of high-speed memory 1312 connected directly with, in close proximity to, and/or integrated as part of processor 1310.

Processor 1310 can include any general-purpose processor and a hardware service or software service, such as services 1332, 1334, and 13313 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 can include an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms known to those of skill in the art. In some instances, multimodal systems can enable a user to provide multiple types of input/output to communicate with computing system 1300. Computing system 1300 can include communications interface 1340, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L#), resistive random-access memory (RRAM/ReRAM), phase change memory (PCM), spin transfer torque RAM (STT-RAM), another memory chip or cartridge, and/or a combination thereof.

Storage device 1330 can include software services, servers, virtual machines, software containers, applications, etc., which, when the code of such software services, servers, virtual machines, software containers, applications, etc., is executed by the processor 1310, causes the system to perform a function. In some examples, a hardware service that performs a particular function can include the software component stored in a computer-readable medium in connection with the necessary hardware components, such as processor 1310, connection 1305, output device 1335, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:
Aspect 1. A computer-implemented method comprising: obtaining sensor data collected by a set of sensors associated with a fire extinguisher installation system used to mount a fire extinguisher to a structure, the sensor data comprising an image depicting a pressure gauge of the fire extinguisher; determining information about a pressure of the fire extinguisher based on the image depicting the pressure gauge of the fire extinguisher; determining a weight of the fire extinguisher based on one or more weight measurements included in the sensor data, the one or more weight measurements being generated by a weight sensor from the set of sensors installed on a mount of the fire extinguisher installation system used to mount the fire extinguisher to the structure; and generating a notification comprising at least one of the information about the pressure of the fire extinguisher, the weight of the fire extinguisher, and compliance information associated with the fire extinguisher, the compliance information being based on at least one of the information about the pressure of the fire extinguisher and the weight of the fire extinguisher.
Aspect 2. The computer-implemented method of Aspect 1, wherein the set of sensors comprises the weight sensor and an image sensor, wherein the image is captured by the image sensor from a position and orientation that aligns a field-of-view (FOV) of the image sensor with a region in space where the pressure gauge is predicted to be when the fire extinguisher is mounted to the structure using the mount.
Aspect 3. The computer-implemented method of Aspect 2, wherein the image sensor is coupled to a top portion of an assembly associated with the mount and held by the top portion of the assembly in the position and orientation that aligns the FOV of the image sensor with the region in space where the pressure gauge is predicted to be when the fire extinguisher is mounted, wherein the top portion of the assembly is shaped as a canopy that protrudes away from a bottom portion of the assembly and is suspended over the mount and the region in space where the pressure gauge is predicted to be when the mount and the assembly are mounted to the structure.
Aspect 4. The computer-implemented method of any of Aspects 2 to 3, wherein the image sensor is implemented by or coupled to a mechanical arm that is coupled to an assembly associated with the mount, wherein the assembly houses a processing system that is communicatively coupled to the one or more sensors, wherein the mechanical arm is moveable from a first pose to a second pose configured to place the image sensor in the position and orientation that aligns the FOV of the image sensor with the region in space where the pressure gauge is predicted to be when the fire extinguisher is mounted to the structure using the mount.
Aspect 5. The computer-implemented method of Aspect 4, wherein the mechanical arm is moveable via at least one of a hinge, a motor configured to move the mechanical arm between the first pose and the second pose, and an actuator configured to move the mechanical arm between the first pose and the second pose, and wherein the mechanical arm includes or is coupled to one or more additional sensors from the set of sensors, the one or more additional sensors comprising at least one of an ultrasonic sensor, an accelerometer, an infrared sensor, a gyroscope, a radio detection and ranging (RADAR) sensor, a light detection and ranging (LIDAR) sensor, a time-of-flight sensor, an ambient light sensor, and a motion sensor.
Aspect 6. The computer-implemented method of any of Aspects 2 to 5, wherein the mount comprises a prong configured to hold the fire extinguisher in place when the fire extinguisher is placed on the mount, wherein the prong is coupled to a sensor assembly comprising the image sensor, wherein a first portion of the sensor assembly is moveable relative to a second portion of the sensor assembly, the first portion of the sensor assembly being moveable from a first pose to a second pose, and wherein the second pose of the first portion of the sensor assembly is configured to place the image sensor in the position and orientation that aligns the FOV of the image sensor with the region in space where the pressure gauge is predicted to be when the fire extinguisher is mounted to the structure using the mount.
Aspect 7. The computer-implemented method of Aspect 6, wherein the first portion of the sensor assembly comprises a paddle that houses the image sensor, and wherein the paddle comprises a spring configured to automatically move to the paddle from the first pose to the second pose when the fire extinguisher is placed on the mount.
Aspect 8. The computer-implemented method of any of Aspects 2 to 7, wherein the fire extinguisher installation system comprises a cabinet configured to house the fire extinguisher, wherein the cabinet comprises the mount and an assembly that houses a processing system communicatively coupled to the set of sensors, wherein the image sensor is coupled to a door of the cabinet, the image sensor being coupled to the interior side of the door in the position and orientation that aligns the FOV of the image sensor with the region in space where the pressure gauge is predicted to be when the fire extinguisher is mounted to the structure using the mount and the cabinet.
Aspect 9. The computer-implemented method of any of Aspects 1 to 8, wherein the set of sensors comprises an image sensor, the computer-implemented method further comprising: obtaining an additional image captured by the image sensor from a position and orientation that aligns a FOV of the image sensor with a region in space where the pressure gauge is predicted to be when the fire extinguisher is mounted to the structure using the mount; determining whether the additional image depicts the pressure gauge; and in response to a failure to detect the pressure gauge in the additional image, generating an alert comprising at least one of a first indication that the failure to detect the pressure gauge and a second indication that the fire extinguisher is not on the mount or was moved from the mount.
Aspect 10. The computer-implemented method of any of Aspects 1 to 9, wherein the compliance information comprises at least one of a weight compliance determined based on the weight of the fire extinguisher and fire extinguisher compliance regulations, a pressure compliance determined based on the information about the pressure of the fire extinguisher and the fire extinguisher compliance regulations, an access compliance determined based on the fire extinguisher compliance regulations and one or more physical obstructions located within a threshold range or perimeter from the fire extinguisher and detected based on the sensor data, and a condition of the fire extinguisher detected based on the sensor data and determined to qualify as a non-compliant tampered state based on the fire extinguisher compliance regulations.
Aspect 11. The computer-implemented method of any of Aspects 1 to 10, wherein the set of sensors comprises the weight sensor and an image sensor, wherein the image sensor is coupled to a mechanical arm via a magnetic coupling and the mechanical arm is coupled to the fire extinguisher, wherein the mechanical arm is configured to hold or place by the image sensor in a position and orientation that aligns a field-of-view (FOV) of the image sensor with the pressure gauge, and wherein the image is captured by the image sensor from the position and orientation that aligns the FOV of the image sensor with the pressure gauge.
Aspect 12. A system comprising: a mount configured to secure a fire extinguisher to a structure, the mount comprising one or more prongs and a weight sensor installed on the one or more prongs; an assembly coupled to one or more sensors; a processing system housed within the assembly and communicatively coupled with the weight sensor and the one or more sensors, the processing system comprising memory and one or more processors coupled to the memory, the one or more processors being configured to: obtain sensor data collected by the weight sensor and the one or more sensors, the sensor data comprising an image depicting a pressure gauge of the fire extinguisher and one or more weight measurements generated by the weight sensor; determine information about a pressure of the fire extinguisher based on the image depicting the pressure gauge of the fire extinguisher; determine a weight of the fire extinguisher based on the one or more weight measurements; and generate a notification comprising at least one of the information about the pressure of the fire extinguisher, the weight of the fire extinguisher, and compliance information associated with the fire extinguisher, the compliance information being based on at least one of the information about the pressure of the fire extinguisher and the weight of the fire extinguisher.
Aspect 13. The system of Aspect 12, wherein the image is captured by an image sensor of the one or more sensors from a position and orientation that aligns a field-of-view (FOV) of the image sensor with a region in space where the pressure gauge is predicted to be when the fire extinguisher is mounted to the structure using the mount.
Aspect 14. The system of Aspect 13, wherein the image sensor is coupled to a top portion of the assembly and held by the top portion of the assembly in the position and orientation that aligns the FOV of the image sensor with the region in space where the pressure gauge is predicted to be when the fire extinguisher is mounted, wherein the top portion of the assembly is shaped as a canopy that protrudes away from a bottom portion of the assembly and is suspended over the mount and the region in space where the pressure gauge is predicted to be when the mount and the assembly are mounted to the structure.
Aspect 15. The system of any of Aspects 13 to 14, wherein the image sensor is implemented by or coupled to a mechanical arm, wherein the mechanical arm is coupled to the assembly, wherein the mechanical arm is moveable from a first pose to a second pose configured to place the image sensor in the position and orientation that aligns the FOV of the image sensor with the region in space where the pressure gauge is predicted to be when the fire extinguisher is mounted to the structure using the mount.
Aspect 16. The system of Aspect 15, wherein the mechanical arm is moveable via at least one of a hinge, a motor configured to move the mechanical arm between the first pose and the second pose, and an actuator configured to move the mechanical arm between the first pose and the second pose, and wherein the mechanical arm includes or is coupled to one or more additional sensors comprising at least one of an ultrasonic sensor, an accelerometer, a gyroscope, a radio detection and ranging (RADAR) sensor, a light detection and ranging (LIDAR) sensor, a time-of-flight sensor, an ambient light sensor, and a motion sensor.
Aspect 17. The system of any of Aspects 13 to 16, wherein the one or more prongs of the mount comprise at least one prong configured to hold the fire extinguisher in place when the fire extinguisher is placed on the mount, wherein the at least one prong is coupled to a sensor assembly comprising the image sensor, wherein a first portion of the sensor assembly is moveable relative to a second portion of the sensor assembly, the first portion of the sensor assembly being moveable from a first pose to a second pose, and wherein the second pose of the first portion of the sensor assembly is configured to place the image sensor in the position and orientation that aligns the FOV of the image sensor with the region in space where the pressure gauge is predicted to be when the fire extinguisher is mounted to the structure using the mount.
Aspect 18. The system of any of Aspects 13 to 17, further comprising a cabinet configured to house the fire extinguisher, wherein the cabinet comprises the mount and the assembly, wherein the image sensor is coupled to a side of a door of the cabinet, the image sensor being coupled to the side of the door in the position and orientation that aligns the FOV of the image sensor with the region in space where the pressure gauge is predicted to be when the fire extinguisher is mounted to the structure using the mount and the cabinet.
Aspect 19. The system of any of Aspects 12 to 18, wherein the one or more processors are configured to: obtain an additional image captured by an image sensor of the one or more sensors, the additional image being captured by the image sensor from a position and orientation that aligns a FOV of the image sensor with a region in space where the pressure gauge is predicted to be when the fire extinguisher is mounted to the structure using the mount; determine whether the additional image depicts the pressure gauge; and in response to a failure to detect the pressure gauge in the additional image, generate an alert comprising at least one of a first indication that the failure to detect the pressure gauge and a second indication that the fire extinguisher is not on the mount or was moved from the mount.
Aspect 20. The system of any of Aspects 12 to 19, wherein the compliance information comprises at least one of a weight compliance determined based on the weight of the fire extinguisher and fire extinguisher compliance regulations, a pressure compliance determined based on the information about the pressure of the fire extinguisher and the fire extinguisher compliance regulations, an access compliance determined based on the fire extinguisher compliance regulations and one or more physical obstructions located within a threshold range or perimeter from the fire extinguisher and detected based on the sensor data, and a condition of the fire extinguisher detected based on the sensor data and determined to qualify as a non-compliant tampered state based on the fire extinguisher compliance regulations.
Aspect 21. The system of any of Aspects 12 to 20, wherein the set of sensors comprises the weight sensor and an image sensor, wherein the image sensor is coupled to a mechanical arm via a magnetic coupling and the mechanical arm is coupled to the fire extinguisher, wherein the mechanical arm is configured to hold or place by the image sensor in a position and orientation that aligns a field-of-view (FOV) of the image sensor with the pressure gauge, and wherein the image is captured by the image sensor from the position and orientation that aligns the FOV of the image sensor with the pressure gauge.
Aspect 22. The system of Aspect 21, further comprising the set of sensors and the mechanical arm.
Aspect 23. A non-transitory computer-readable medium having stored thereon instructions which, when executed by one or more processors, cause the one or more processors to perform a method according to any of Aspects 1 to 11.

What is claimed is:

1. A computer-implemented method comprising:
obtaining sensor data collected by a set of sensors associated with a fire extinguisher installation system used to mount a fire extinguisher to a structure, the sensor data comprising an image depicting a pressure gauge of the fire extinguisher;
determining information about a pressure of the fire extinguisher based on the image depicting the pressure gauge of the fire extinguisher;
determining a weight of the fire extinguisher based on one or more weight measurements included in the sensor data, the one or more weight measurements being generated by a weight sensor from the set of sensors installed on a mount of the fire extinguisher installation system used to mount the fire extinguisher to the structure; and
generating a notification comprising at least one of the information about the pressure of the fire extinguisher, the weight of the fire extinguisher, and compliance information associated with the fire extinguisher, the compliance information being based on at least one of the information about the pressure of the fire extinguisher and the weight of the fire extinguisher.

2. The computer-implemented method of claim 1, wherein the set of sensors comprises the weight sensor and an image sensor, wherein the image is captured by the image sensor from a position and orientation that aligns a field-of-view (FOV) of the image sensor with a region in space where the pressure gauge is predicted to be when the fire extinguisher is mounted to the structure using the mount.

3. The computer-implemented method of claim 2, wherein the image sensor is coupled to a top portion of an assembly associated with the mount and held by the top portion of the assembly in the position and orientation that aligns the FOV of the image sensor with the region in space where the pressure gauge is predicted to be when the fire extinguisher is mounted, wherein the top portion of the assembly is shaped as a canopy that protrudes away from a bottom portion of the assembly and is suspended over the mount and the region in space where the pressure gauge is predicted to be when the mount and the assembly are mounted to the structure.

4. The computer-implemented method of claim 2, wherein the image sensor is implemented by or coupled to a mechanical arm that is coupled to an assembly associated with the mount, wherein the assembly houses a processing system that is communicatively coupled to the one or more sensors, wherein the mechanical arm is moveable from a first pose to a second pose configured to place the image sensor in the position and orientation that aligns the FOV of the image sensor with the region in space where the pressure gauge is predicted to be when the fire extinguisher is mounted to the structure using the mount.

5. The computer-implemented method of claim 4, wherein the mechanical arm is moveable via at least one of a hinge, a motor configured to move the mechanical arm between the first pose and the second pose, and an actuator configured to move the mechanical arm between the first pose and the second pose, and wherein the mechanical arm includes or is coupled to one or more additional sensors from the set of sensors, the one or more additional sensors comprising at least one of an ultrasonic sensor, an accelerometer, an infrared sensor, a gyroscope, a radio detection and ranging (RADAR) sensor, a light detection and ranging (LIDAR) sensor, a time-of-flight sensor, an ambient light sensor, and a motion sensor.

6. The computer-implemented method of claim 2, wherein the mount comprises a prong configured to hold the fire extinguisher in place when the fire extinguisher is placed on the mount, wherein the prong is coupled to a sensor assembly comprising the image sensor, wherein a first portion of the sensor assembly is moveable relative to a second portion of the sensor assembly, the first portion of the sensor assembly being moveable from a first pose to a second pose, and wherein the second pose of the first portion of the sensor assembly is configured to place the image sensor in the position and orientation that aligns the FOV of the image sensor with the region in space where the pressure gauge is predicted to be when the fire extinguisher is mounted to the structure using the mount.

7. The computer-implemented method of claim 6, wherein the first portion of the sensor assembly comprises a paddle that houses the image sensor, and wherein the paddle comprises a spring configured to automatically move to the paddle from the first pose to the second pose when the fire extinguisher is placed on the mount.

8. The computer-implemented method of claim 2, wherein the fire extinguisher installation system comprises a cabinet configured to house the fire extinguisher, wherein the cabinet comprises the mount and an assembly that houses a processing system communicatively coupled to the set of sensors, wherein the image sensor is coupled to a door of the cabinet, the image sensor being coupled to the interior side of the door in the position and orientation that aligns the FOV of the image sensor with the region in space where the pressure gauge is predicted to be when the fire extinguisher is mounted to the structure using the mount and the cabinet.

9. The computer-implemented method of claim 1, wherein the set of sensors comprises an image sensor, the computer-implemented method further comprising:
obtaining an additional image captured by the image sensor from a position and orientation that aligns a FOV of the image sensor with a region in space where the pressure gauge is predicted to be when the fire extinguisher is mounted to the structure using the mount;
determining whether the additional image depicts the pressure gauge; and
in response to a failure to detect the pressure gauge in the additional image, generating an alert comprising at least one of a first indication that the failure to detect the pressure gauge and a second indication that the fire extinguisher is not on the mount or was moved from the mount.

10. The computer-implemented method of claim 1, wherein the compliance information comprises at least one of a weight compliance determined based on the weight of the fire extinguisher and fire extinguisher compliance regulations, a pressure compliance determined based on the information about the pressure of the fire extinguisher and the fire extinguisher compliance regulations, an access compliance determined based on the fire extinguisher compliance regulations and one or more physical obstructions located within a threshold range or perimeter from the fire extinguisher and detected based on the sensor data, and a condition of the fire extinguisher detected based on the sensor data and determined to qualify as a non-compliant tampered state based on the fire extinguisher compliance regulations.

11. The computer-implemented method of claim 1, wherein the set of sensors comprises the weight sensor and an image sensor, wherein the image sensor is coupled to a mechanical arm via a magnetic coupling and the mechanical arm is coupled to the fire extinguisher, wherein the mechanical arm is configured to hold or place by the image sensor in a position and orientation that aligns a field-of-view (FOV) of the image sensor with the pressure gauge, and wherein the image is captured by the image sensor from the position and orientation that aligns the FOV of the image sensor with the pressure gauge.

12. A system comprising:
a mount configured to secure a fire extinguisher to a structure, the mount comprising one or more prongs and a weight sensor installed on the one or more prongs;
an assembly coupled to one or more sensors;
a processing system housed within the assembly and communicatively coupled with the weight sensor and the one or more sensors, the processing system comprising memory and one or more processors coupled to the memory, the one or more processors being configured to:
obtain sensor data collected by the weight sensor and the one or more sensors, the sensor data comprising an image depicting a pressure gauge of the fire extinguisher and one or more weight measurements generated by the weight sensor;
determine information about a pressure of the fire extinguisher based on the image depicting the pressure gauge of the fire extinguisher;
determine a weight of the fire extinguisher based on the one or more weight measurements; and
generate a notification comprising at least one of the information about the pressure of the fire extinguisher, the weight of the fire extinguisher, and compliance information associated with the fire extinguisher, the compliance information being based on at least one of the information about the pressure of the fire extinguisher and the weight of the fire extinguisher.

13. The system of claim 12, wherein the image is captured by an image sensor of the one or more sensors from a position and orientation that aligns a field-of-view (FOV) of the image sensor with a region in space where the pressure gauge is predicted to be when the fire extinguisher is mounted to the structure using the mount.

14. The system of claim 13, wherein the image sensor is coupled to a top portion of the assembly and held by the top portion of the assembly in the position and orientation that aligns the FOV of the image sensor with the region in space where the pressure gauge is predicted to be when the fire extinguisher is mounted, wherein the top portion of the assembly is shaped as a canopy that protrudes away from a bottom portion of the assembly and is suspended over the mount and the region in space where the pressure gauge is predicted to be when the mount and the assembly are mounted to the structure.

15. The system of claim 13, wherein the image sensor is implemented by or coupled to a mechanical arm, wherein the mechanical arm is coupled to the assembly, wherein the mechanical arm is moveable from a first pose to a second pose configured to place the image sensor in the position and orientation that aligns the FOV of the image sensor with the region in space where the pressure gauge is predicted to be when the fire extinguisher is mounted to the structure using the mount.

16. The system of claim 15, wherein the mechanical arm is moveable via at least one of a hinge, a motor configured to move the mechanical arm between the first pose and the second pose, and an actuator configured to move the mechanical arm between the first pose and the second pose, and wherein the mechanical arm includes or is coupled to one or more additional sensors comprising at least one of an ultrasonic sensor, an accelerometer, a gyroscope, a radio detection and ranging (RADAR) sensor, a light detection and ranging (LIDAR) sensor, a time-of-flight sensor, an ambient light sensor, and a motion sensor.

17. The system of claim 13, wherein the one or more prongs of the mount comprise at least one prong configured to hold the fire extinguisher in place when the fire extinguisher is placed on the mount, wherein the at least one prong is coupled to a sensor assembly comprising the image sensor, wherein a first portion of the sensor assembly is moveable relative to a second portion of the sensor assembly, the first portion of the sensor assembly being moveable from a first pose to a second pose, and wherein the second pose of the first portion of the sensor assembly is configured to place the image sensor in the position and orientation that aligns the FOV of the image sensor with the region in space where the pressure gauge is predicted to be when the fire extinguisher is mounted to the structure using the mount.

18. The system of claim 13, further comprising a cabinet configured to house the fire extinguisher, wherein the cabinet comprises the mount and the assembly, wherein the image sensor is coupled to a side of a door of the cabinet, the image sensor being coupled to the side of the door in the position and orientation that aligns the FOV of the image sensor with the region in space where the pressure gauge is predicted to be when the fire extinguisher is mounted to the structure using the mount and the cabinet.

19. The system of claim 12, wherein the image is captured by an image sensor of the one or more sensors that is coupled, via a magnetic coupling, to a mechanical arm coupled to the fire extinguisher, wherein the compliance information comprises at least one of a weight compliance determined based on the weight of the fire extinguisher and fire extinguisher compliance regulations, a pressure compliance determined based on the information about the pressure of the fire extinguisher and the fire extinguisher compliance regulations, an access compliance determined based on the fire extinguisher compliance regulations and one or more physical obstructions located within a threshold range or perimeter from the fire extinguisher and detected based on the sensor data, and a condition of the fire extinguisher detected based on the sensor data and determined to qualify as a non-compliant tampered state based on the fire extinguisher compliance regulations.

20. A non-transitory computer-readable medium having stored thereon instructions which, when executed by one or more processors, cause the one or more processors to:
obtain sensor data collected by a set of sensors associated with a fire extinguisher installation system used to mount a fire extinguisher to a structure, the sensor data comprising an image depicting a pressure gauge of the fire extinguisher;
determine information about a pressure of the fire extinguisher based on the image depicting the pressure gauge of the fire extinguisher;
determine a weight of the fire extinguisher based on one or more weight measurements included in the sensor data, the one or more weight measurements being generated by a weight sensor from the set of sensors installed on a mount of the fire extinguisher installation system used to mount the fire extinguisher to the structure; and
generate a notification comprising at least one of the information about the pressure of the fire extinguisher, the weight of the fire extinguisher, and compliance information associated with the fire extinguisher, the compliance information being based on at least one of the information about the pressure of the fire extinguisher and the weight of the fire extinguisher.
